(19) United States
(12) Patent Application Publication
(10) Pub. No.: US 2014/0303951 A1
(43) Pub. Date: Oct. 9, 2014

(54) INTEGRATED SYSTEM FOR PRODUCTION DESIGN ASSISTANCE

(71) Applicant: Schlumberger Technology Corporation, Sugar Land, TX (US)

(72) Inventors: Fabien Houeto, Sugar Land, TX (US); Rodney Lessard, Katy, TX (US); Carlos Santieri de Figueiredo Boneti, Houston, TX (US); Bobby Kiehn, Houston, TX (US)

(73) Assignee: Schlumberger Technology Corporation, Sugar Land, TX (US)

(21) Appl. No.: 14/246,689

(22) Filed: Apr. 7, 2014

Related U.S. Application Data
(60) Provisional application No. 61/810,079, filed on Apr. 9, 2013.

(51) Int. Cl. G06F 17/50

(52) U.S. Cl. CPC G06F 17/5009
USPC 703/10

(57) ABSTRACT

A method can include rendering terrain and equipment locations to a display; assigning one or more domain constraints; analyzing an objective function associated with the terrain and the equipment locations subject to at least one of the one or more domain constraints; and rendering information to the display based at least in part on the analyzing. Various other technologies, techniques, etc., are also disclosed.

### RELATED APPLICATIONS

This applications claims priority to and the benefit of a U.S. Provisional Patent Application Ser. No. 61/810,079, filed 9 Apr. 2013, which is incorporated herein by reference.

### BACKGROUND

Production systems can provide for transportation of oil and gas fluids from well locations to processing facilities and represent a substantial investment in infrastructure with both economic and environmental impact. Simulation of such systems, which may include hundreds or thousands of flowlines and pieces of production equipment interconnected at junctions to form a network, can be a formidable task.

### SUMMARY

A method can include rendering terrain and equipment locations to a display; assigning one or more domain constraints; analyzing an objective function associated with the terrain and the equipment locations subject to at least one of the one or more domain constraints; and rendering information to the display based at least in part on the analyzing.

A system can include a processor; memory operatively coupled to the processor; and one or more modules storable in the memory that comprise instructions executable by the processor to instruct the system to render terrain and equipment locations to a display; assign one or more domain constraints; analyze an objective function associated with the terrain and the equipment locations subject to at least one of the one or more domain constraints; and render information to the display based at least in part on an analysis of the objective function.

One or more computer-readable storage media can include computer-executable instructions executable by a computer to instruct the computer to render terrain and equipment locations to a display; assign one or more domain constraints; analyze an objective function associated with the terrain and the equipment locations subject to at least one of the one or more domain constraints; and render information to the display based at least in part on an analysis of the objective function.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example field system that includes various components, an example of a method and an example of a device or system;

FIG. 2 illustrates an example of a system;

FIG. 3 illustrates an example of a system;

FIG. 4 illustrates an example of a network, an example of a system and examples of modules;

FIGS. 5-9 illustrate examples of graphical user interfaces;

FIG. 10 illustrates an example of a system and an example of a method;

FIG. 11 illustrates an example of a scenario and examples of associated data and graphical user interfaces;

FIG. 12 illustrates an example of a graphical user interface, an example of a method and examples of modules;

FIG. 13 illustrates an example of a workflow and an example of method;

FIGS. 14-16 illustrate examples of, graphical user interfaces-associated with the workflow of FIG. 13; and

FIG. 17 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

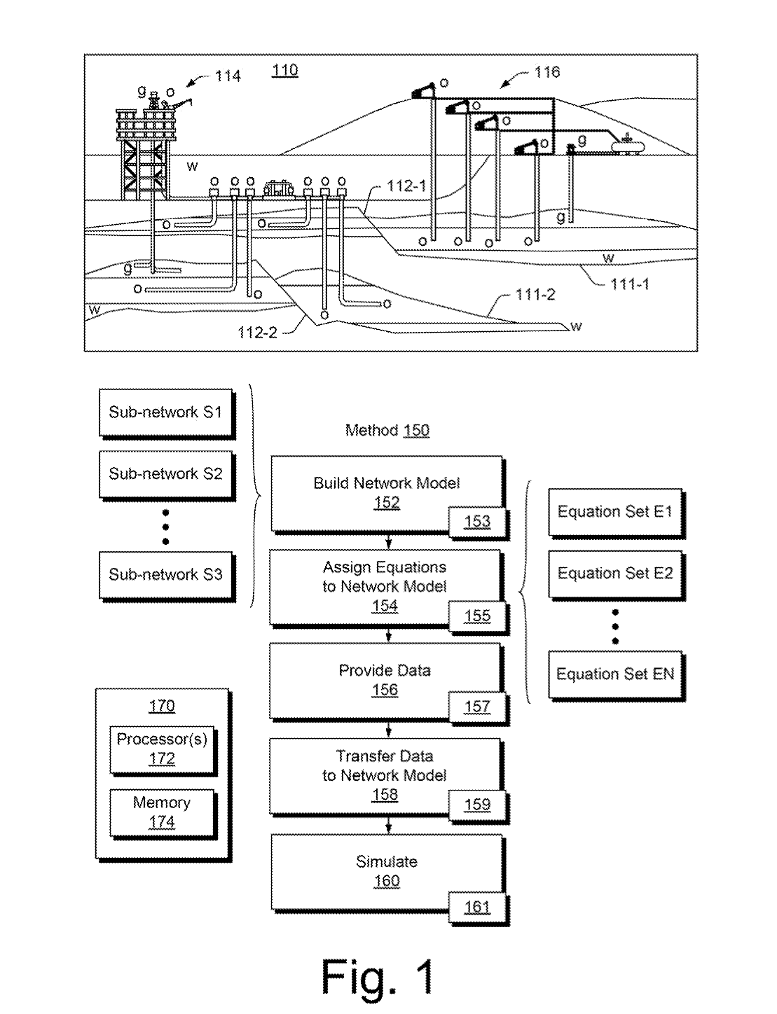

FIG. 1 shows an example of a geologic environment 110 that includes reservoirs 111-1 and 111-2, which may be faulted by faults 112-1 and 112-2, an example of a method 150 and an example of a device or system 170. FIG. 1 also shows some examples of offshore equipment 114 for oil and gas operations related to the reservoirs 111-1 and 111-2 and onshore equipment 116 for oil and gas operations related to the reservoir 111-1.

As an example, a model may be made that models a geologic environment in combination with equipment, wells, etc. For example, a model may be a flow simulation model for use by a simulator to simulate flow in an oil, gas or oil and gas production system. Such a flow simulation model may include equations, for example, to model multiphase flow from a reservoir to a wellhead, from a wellhead to a reservoir, etc. A flow simulation model may also include equations that account for flowline and surface facility performance, for example, to perform a comprehensive production system analysis.

As an example, a flow simulation model may be a network model that includes various sub-networks specified using nodes, segments, branches, etc. As an example, a flow simulation model may be specified in a manner that provides for modeling of branched segments, multilateral segments, complex completions, intelligent downhole controls, etc.

As an example, a system may provide for transportation of oil and gas fluids from well locations to processing facilities and may represent a substantial investment in infrastructure with both economic and environmental impact. Simulation of such a system, which may include hundreds or thousands of flow lines and production equipment interconnected at junctions to form a network, can involve multiphase flow science and, for example, use of engineering and mathematical techniques for large systems of equations.

As an example, a flow simulation model may include equations for performing nodal analysis, pressure-volume-temperature (PVT) analysis, gas lift analysis, erosion analysis, corrosion analysis, production analysis, injection analysis, etc. In such an example, one or more analyses may be based, in part, on a simulation of flow in a modeled network.

As to nodal analysis, it may provide for evaluation of well performance, for making decisions as to completions, etc. A nodal analysis may provide for an understanding of behavior of a system and optionally sensitivity of a system (e.g., production, injection, production and injection). For example, a system variable may be selected for investigation and a sensitivity analysis performed. Such an analysis may include plotting inflow and outflow of fluid at a nodal point or nodal points in the system, which may indicate where certain opportunities exist (e.g., for injection, for production, etc.).

A modeling framework may include modules to facilitate generation of a flow simulation model. For example, a module may provide for modeling completions for vertical wells, completions for horizontal wells, completions for fractured wells, etc. A modeling framework may include modules for particular types of equations, for example, black-oil equations, equation-of-state (EOS) equations, etc. A modeling framework may include modules for artificial lift, for example, to model fluid injection, fluid pumping, etc. As an example, consider a module that includes features for modeling one or more electric submersible pumps (ESPs) (e.g., based in part on pump performance curves, motors, cables, etc.).

As an example, an analysis using a flow simulation model may be a network analysis to: identify production bottlenecks and constraints; assess benefits of new wells, additional pipelines, compression systems, etc.; calculate deliverability from field gathering systems; predict pressure and temperature profiles through flow paths; or plan full-field development.

As an example, a flow simulation model may provide for analyses with respect to future times, for example, to allow for optimization of production equipment, injection equipment, etc. As an example, consider an optimal time-based and conditional-event logic representation for daily field development operations that can be used to evaluate drilling of new developmental wells, installing additional processing facilities over time, choke-adjusted wells to meet production and operating limits, shutting in of depleting wells as reservoir conditions decline, etc.

As to equations, a flow simulation model may include one or more sets of equations for three-phase mechanistic multiphase flow (e.g., according to one or more of a LedaFlow™ point model (Kongsberg Oil & Gas Technologies AS, Sandvika, Norway), ALGA-S™ model (Schlumberger Ltd, Houston, Tex.), TUFFP unified mechanistic models (Tulsa University Fluid Flow Projects, Tulsa, Okla.), etc.).

As to the method 150 of FIG. 1, it can include a build block 152 for building a network model that represents a production system for fluid; an assignment block 154 for assigning equations to sub-networks in the network model (e.g., where at least one of the sub-networks is optionally assigned equations formulated for solving for enthalpy implicitly or temperature implicitly), a provision block 156 for providing data; a transfer block 158 for transferring the data to the network model; and a simulation block 160 for simulating physical phenomena associated with the production system using the network model to provide simulation results.

The method 150 is shown in FIG. 1 in association with various computer-readable media (CRM) blocks 153, 155, 157, 159 and 161. Such blocks generally include instructions suitable for execution by one or more processors (or processing cores) 172 to instruct the computing device or system 170 to perform one or more actions. While various blocks are shown, a single medium may be configured with instructions to allow for, at least in part, performance of various actions of the method 150. As an example, a computer-readable medium (CRM) may be a computer-readable storage medium, for example, such as a memory device 174 of the computing device or system 170, where the memory device 174 includes memory.

A production system can include equipment, for example, where a piece of equipment of the production system may be represented in a sub-network of a network model and, for example, assigned equations formulated to represent the piece of equipment as non-adiabatic (e.g., or adiabatic). As an example, a piece of equipment may include an electric motor operatively coupled to a mechanism to move fluid (e.g., a pump, compressor, etc.). As an example, a piece of equipment may include a heater coupled to a power source, a fuel source, etc. (e.g., consider a steam generator). As an example, a piece of equipment may include a conduit for delivery of fluid where the fluid may be for delivery of heat energy (e.g., consider a steam injector). As an example, a piece of equipment may include a conduit for delivery of a substance (e.g., a chemical, a proppant, etc.).

As an example, a sub-network may be assigned equations formulated for solving for enthalpy implicitly or temperature implicitly to represent fluid at or near a critical point, to represent heavy oil, to represent steam, to represent water or one or more other fluids (e.g., optionally subject to certain physical phenomena such as pressure, temperature, etc.).

As an example, a system can include a processor; a memory device having memory accessible by the processor; and one or more modules that include processor-executable instructions stored in the memory of the memory device, the instructions executable to instruct the system to: build a network model that represents a production system for fluid, assign equations to sub-networks in the network model, provide data, transfer the data to the network model, and simulate physical phenomena associated with the production system using the network model to provide simulation results.

As an example, a system can include a sub-network assigned equations formulated for steam associated with equipment for an enhanced oil recovery (EOR) process (e.g., steam-assisted gravity drainage (SAGD) and/or other EOR process).

As an example, a system can include a sub-network that represents a piece of equipment of a production system by assigning that sub-network equations formulated to represent the piece of equipment. In such an example, the piece of equipment may include an electric motor operatively coupled to a mechanism to move fluid (e.g., a compressor, a pump, etc.).

As an example, one or more computer-readable media can include computer-executable instructions executable by a computer to instruct the computer to: receive simulation results for physical phenomena associated with a production system modeled by a network model: and analyze the simulation results.

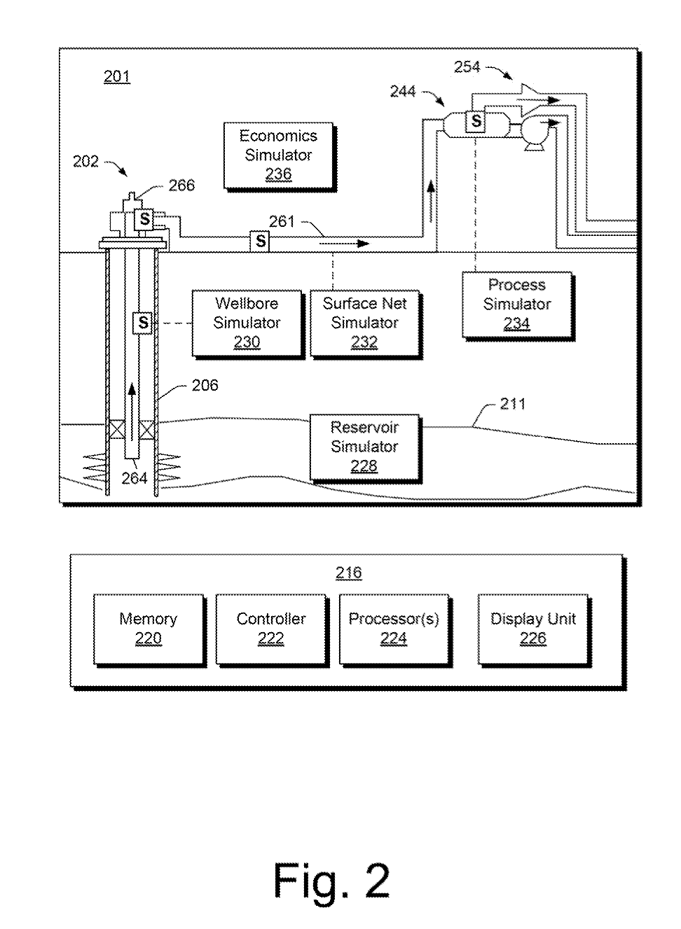

FIG. 2 shows an example of a schematic view of a portion of a geologic environment 201 that includes equipment. As shown in FIG. 2, the environment 201 includes a wellsite 202 and a network 244. The wellsite 202 includes a wellbore 206 extending into earth as completed and prepared for production of fluid from a reservoir 211.

In the example of FIG. 2, wellbore production equipment 264 extends from a wellhead 266 of the wellsite 202 and to the reservoir 211 to draw fluid to the surface. As shown, the wellsite 202 is operatively connected to the network 244 via a transport line 261. As indicated by various arrows, fluid can flow from the reservoir 211, through the wellbore 206 and onto the network 244. Fluid can then flow from the network 244, for example, to one or more fluid processing facilities.

In the example of FIG. 2, sensors (S) are located, for example, to monitor various parameters during operations. The sensors (S) may measure, for example, pressure, temperature, flowrate, composition, and other parameters of the reservoir, wellbore, gathering network, process facilities and/or other portions of an operation. As an example, the sensors (S) may be operatively connected to a surface unit 216 (e.g., to instruct the sensors to acquire data, to collect data from the sensors, etc.).

In the example of FIG. 2, the surface unit 216 can include computer facilities, such as a memory device 220, a controller 222, one or more processors 224, and display unit 226 (e.g., for managing data, visualizing results of an analysis, etc.). As an example, data may be collected in the memory device 220 and processed by the processor(s) 224 (e.g., for analysis, etc.). As an example, data may be collected from the sensors (S) and/or by one or more other sources. For example, data may be supplemented by historical data collected from other operations, user inputs, etc. As an example, analyzed data may be used to in a decision making process.

In the example of FIG. 2, a transceiver may be provided to allow communications between the surface unit 216 and one or more pieces of equipment in the environment 201. For example, the controller 222 may be used to actuate mechanisms in the environment 201 via the transceiver, optionally based on one or more decisions of a decision making process. In such a manner, equipment in the environment 201 may be selectively adjusted based at least in part on collected data. Such adjustments may be made, for example, automatically based on computer protocol, manually by an operator or both. As an example, one or more well plans may be adjusted (e.g., to select optimum operating conditions, to avoid problems, etc.).

To facilitate data analyses, one or more simulators may be implemented (e.g., optionally via the surface unit 216 or other unit, system, etc.). As an example, data fed into one or more simulators may be historical data, real time data or combinations thereof. As an example, simulation through one or more simulators may be repeated or adjusted based on the data received.

In the example of FIG. 2, simulators can include a reservoir simulator 228, a wellbore simulator 230, and a surface network simulator 232, a process simulator 234 and an economics simulator 236. As an example, the reservoir simulator 228 may be configured to solve for hydrocarbon flow rate through a reservoir and into one or more wellbores. As an example, the wellbore simulator 230 and surface network simulator 232 may be configured to solve for hydrocarbon flow rate through a wellbore and a surface gathering network of pipelines. As to the process simulator 234, it may be configured to model a processing plant where fluid containing hydrocarbons is separated into its constituent components (e.g., methane, ethane, propane, etc.), for example, and prepared for further distribution (e.g., transport via road, rail, pipe, etc.) and optionally sale. As an example, the economics simulator 236 may be configured to model costs associated with at least part of an operation.

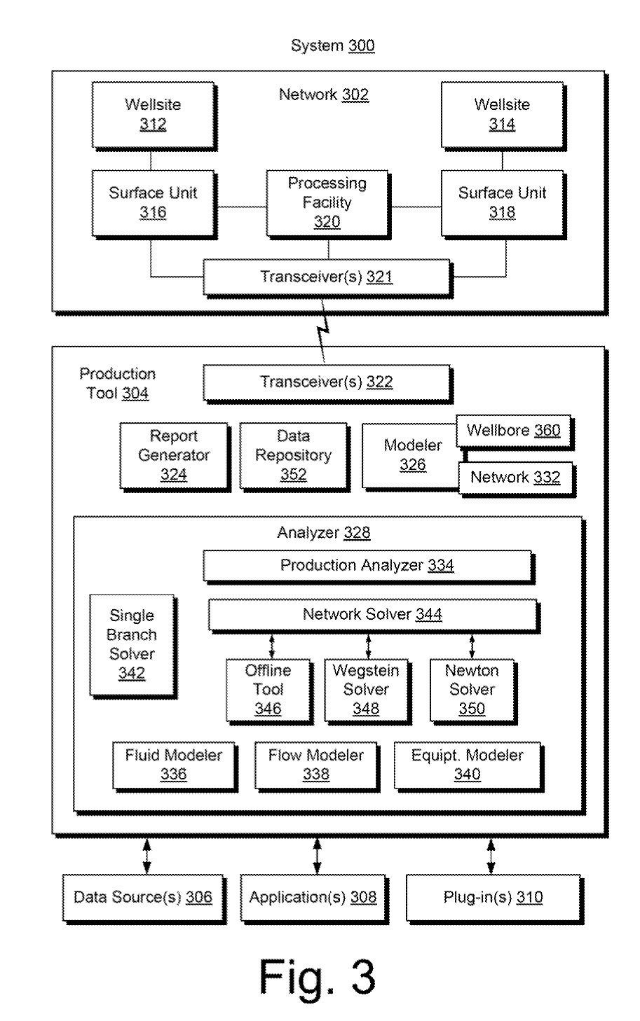

FIG. 3 shows an example of a schematic diagram of a production system 300 for performing oilfield production operations. As shown in the example of FIG. 3, the production system 300 can include an oilfield network 302, an oilfield production tool 304, one or more data sources 306, one or more oilfield application(s) 308, and one or more plug-in(s) 310. As an example, the oilfield network 302 can be an interconnection of pipes (e.g., conduits) that connects welisites (e.g., a wellsite 1 312, a wellsite n 314, etc.) to a processing facility 320. A pipe in the oilfield network 302 may be connected to a processing facility (e.g., a processing facility 320), a wellsite (e.g., the wellsite 1 312, the wellsite n 314, etc.), and/or a junction in which pipes are connected. As an example, flow rate of fluid and/or gas into pipes may be adjustable; thus, certain pipes in the oilfield network 302 may be choked or closed so as to not allow fluid and/or gas through the pipe. A pipe may be considered open (e.g., optionally choked) when the pipe allows for flow of fluid and/or gas. As to a choke, choking may allow for adjusting one or more characteristics of a piece of flow equipment (e.g., a cross-sectional flow area, etc.), for example, for adjusting to fully open flow, for adjusting to choked flow and/or for adjusting to no flow (e.g., closed).

As an example, a choke may include an orifice that is used to control fluid flow rate or downstream system pressure. As an example, a choke may be provided in any of a variety of configurations (e.g., for fixed and/or adjustable modes of operation). As an example, an adjustable choke may enable fluid flow and pressure parameters to be changed to suit process or production requirements. As an example, a fixed choke may be configured for resistance to erosion under prolonged operation or production of abrasive fluids.

The oilfield network 302 may be a gathering network and/or an injection network. A gathering network may be an oilfield network used to obtain hydrocarbons from a wellsite (e.g., the wellsite 1 312, the wellsite n 314, etc.). In a gathering network, hydrocarbons may flow from the wellsites to the processing facility 320. An injection network may be an oilfield network used to inject the wellsites with injection substances, such as water, carbon dioxide, and other chemicals that may be injected into the wellsites. In an injection network, the flow of the injection substance may flow towards the wellsite (e.g., toward the wellsite 1 312, the wellsite n 314, etc.).

The oilfield network 302 may also include one or more surface units (e.g., a surface unit 1 316, a surface unit n 318, etc.), for example, a surface unit for each wellsite. Such surface units may include functionality to collect data from sensors (see, e.g., the surface unit 216 of FIG. 2). Such sensors may include sensors for measuring flow rate, water cut, gas lift rate, pressure, and/or other such variables related to measuring and monitoring hydrocarbon production. As shown, the oilfield network 302 can include one or more transceivers 321, for example, to receive information, to transmit information, to receive information and transmit information, etc. As an example, information may be received and/or transmitted via wire and/or wirelessly. As an example, information may be received and/or transmitted via a communications network such as, for example, the Internet, the Cloud, a cellular network, a satellite network, etc.

As an example, the oilfield production tool 304 may be connected to the oilfield network 302. The oilfield production tool 304 may be a simulator (e.g., a simulation framework) or a plug-in for a simulator (e.g., or other application(s)). The oilfield production tool 304 may include one or more transceivers 322, a report generator 324, an oilfield modeler 326, and an oilfield analyzer 328. As an example, the one or more transceivers 322 may be configured to receive information, to transmit information, to receive information and transmit information, etc. As an example, information may be received and/or transmitted via wire and/or wirelessly. As an example, information may be received and/or transmitted via a communications network such as, for example, the Internet, the Cloud, a cellular network, a satellite network, etc.

As an example, one or more of the one or more transceivers 322 may include functionality to collect oilfield data. The oilfield data may be data from sensors, historical data, or any other such data. One or more of the one or more transceivers 322 may also include functionality to interact with a user and display data such as a production result.

As an example, the report generator 324 can include functionality to produce graphical and textual reports. Such reports may show historical oilfield data, production models, production results, sensor data, aggregated oilfield data, or any other such type of data.

As an example, the data repository 352 may be a storage unit and/or device (e.g., a file system, database, collection of tables, or any other storage mechanism) for storing data, such as the production results, sensor data, aggregated oilfield data, or any other such type of data. As an example, the data repository 352 may include multiple different storage units and/or hardware devices. Such multiple different storage units and/or devices may or may not be of the same type or located at the same physical site. As an example, the data repository 352, or a portion thereof, may be secured via one or more security protocols, whether physical, algorithmic or a combination thereof (e.g., data encryption, secure device access, secure communication, etc.).

In the example of FIG. 3, the oilfield modeler 326 can include functionality to create a model of a wellbore and an oilfield network. As shown, the oilfield modeler 326 includes a wellbore modeler 330 and a network modeler 332. As an example, the wellbore modeler 330 can allow a user to create a graphical wellbore model or single branch model. As an example, a wellbore model can define operating parameters (e.g., actual, theoretical, etc.) of a wellbore (e.g., pressure, flow rate, etc). As an example, a single branch model may define operating parameters of a single branch in an oilfield network.

As to the network modeler 332, it may allow a user to create a graphical network model that combines wellbore models and/or single branch models. As an example, the network modeler 328 and/or wellbore modeler 330 may model pipes in the oilfield network 302 as branches of the oilfield network 302 (e.g., optionally as one or more segments, optionally with one or more nodes, etc.). In such an example, each branch may be connected to a wellsite or a junction. A junction may be defined as a group of two or more pipes that intersect at a particular location (e.g. a junction may be a node or a type of node).

As an example, a modeled oilfield network may be formed as a combination of sub-networks. In such an example, a sub-network may be defined as a portion of an oilfield network. For example, a sub-network may be connected to the oilfield network 302 using at least one branch. Sub-networks may be a group of connected wellsites, branches, and junctions. As an example, sub-networks may be disjoint (e.g., branches and wellsites in one sub-network may not exist in another sub-network).

As an example, the oilfield analyzer 328 can include functionality to analyze the oilfield network 302 and generate a production result for the oilfield network 302. As shown in the example of FIG. 3, the oilfield analyzer 328 may include one or more of the following: a production analyzer 334, a fluid modeler 336, a flow modeler 338, an equipment modeler 340, a single branch solver 342, a network solver 344, a Wegstein solver 346, a Newton solver 350, and an offline tool 346.

As an example, the production analyzer 334 can include functionality to receive a workflow request and interact with the single branch solver 342 and/or the network solver 344 based on particular aspects of the workflow. For example, the workflow may include a nodal analysis to analyze a wellsite or junction of branches, pressure and temperature profile, model calibration, gas lift design, gas lift optimization, network analysis, and other such workflows.

As an example, the fluid modeler 336 can include functionality to calculate fluid properties (e.g., phases present, densities, viscosities, etc.) using one or more compositional and/or black-oil fluid models. The fluid modeler 336 may include functionality to model oil, gas, water, hydrate, wax, and asphaltene phases. As an example, the flow modeler 338 can include functionality to calculate pressure drop in pipes (e.g., pipes, tubing, etc.) using industry standard multiphase flow correlations. As an example, the equipment modeler 340 can include functionality to calculate pressure changes in equipment pieces (e.g., chokes, pumps, compressors, etc.). As an example, one or more substances may be introduced via a network for purposes of managing asphaltenes, waxes, etc. As an example, a modeler may include functionality to model interaction between one or more substances and fluid (e.g., including material present in the fluid).

As an example, the single branch solver 342 may include functionality to calculate the flow and pressure drop in a wellbore or a single flowline branch given various inputs.

As an example, the network solver 344 can includes functionality calculate a flow rate and pressure drop throughout the oilfield network 302. The network solver 344 may be configured to connect to the offline tool 346, the Wegstein solver 348, and the Newton solver 350. As an example, alternatively or additionally, one or more other solvers may be provided, for example, consider a sequential linear programming solver (SLP), a sequential quadratic programming solver (SOP), etc. As an example, a solver may be part of the production tool 304, part of the analyzer 328 of the production tool 304, part of a system to which the production tool 304 may be operatively coupled, etc.

As an example, the offline tool 346 may include a wells offline tool and a branches offline tool. A wells offline tool may include functionality to generate a production model using the single branch solver 342 for a wellsite or branch. A branches offline tool may include functionality to generate a production model for a sub-network using the production model for a wellsite, a single branch, or a sub-network of the sub-network.

As an example, a production model may be capable of providing a description of a wellsite with respect to various operational conditions. A production model may include one or more production functions that may be combined, for example, where each production function may be a function of variables related to the production of hydrocarbons. For example, a production function may be a function of flow rate and/or pressure. Further, a production function may account for environmental conditions related to a sub-network of the oilfield network 302, such as changes in elevation (e.g., for gravity head, pressure, etc.), diameters of pipes, combination of pipes, and changes in pressure resulting from joining pipes. A production model may provide estimates of flow rate for a wellsite or sub-network of an oilfield network.

As an example, one or more separate production functions may exist that can account for changes in one or more values of an operational condition. An operational condition may identify a property of hydrocarbons or injection substance. For example, an operational condition may include a watercut (WC), reservoir pressure, gas lift rate, etc. Other operational conditions, variables, environmental conditions may be considered.

As to the network solver 344, in the example of FIG. 3, it is shown as being connected to the Wegstein solver 348 and/or the Newton solver 350. The Wegstein solver 348 and the Newton solver 350 include functionality to combine a production model for several sub-networks to create a production result that may be used to plan an oilfield network, optimize flow rates of wellsites in an oilfield network, and/or identify and address faulty components within an oilfield network. The Wegstein solver 348 can use an iterative method with Wegstein acceleration.

An oilfield network may be solved by identifying pressure drop (e.g., pressure differential), for example, through use of momentum equations. As an example, an equation for pressure differential may account for factors such as fluid potential energy (e.g., hydrostatic pressure), friction (e.g., shear stress between conduit wall and fluid), and acceleration (e.g., change in fluid velocity). As an example, an equation may be expressed in terms of static reservoir pressure, a flowing bottom hole pressure and flowrate. As an example, equations may account for vertical, horizontal or angled arrangements of equipment. Various examples of equations may be found in a multiphase flow simulator such as the simulator of the PIPESIM™ simulation framework (Schlumberger Limited, Houston, Tex.), which may be implemented for design and diagnostic analysis of oil and gas production systems. As an example, a simulation framework may include one or more modules for building a model; for fluid and multiphase flow modeling; for reservoir, well and completion modeling; for field equipment modeling; and for operations (e.g., artificial lift, gas lift, wax prediction, nodal analysis, network analysis, field planning, multi-well analysis, etc.).

As an example, an equation for a pressure differential (e.g., ΔP) may be rearranged to solve for flow rate (e.g., Q), where the equation may include the Reynolds number (e.g., Re, a dimensionless ratio of inertial to viscous forces), one or more friction factors (e.g., which may depend on flow regime), etc.

Through use of equations for flow into and out of a branch and equating to zero, a linear matrix in unknown pressures may be obtained. As an example, fixed flow branches (i.e., branches in which the flow does not change) may be solved directly for the node pressures.

Thus, as an example, the Wegstein Solver 348 may perform a process as follows: (1) obtain initial estimates for the frictional and elevational resistances from the production models; (2) solve the linear system for the unknown node pressures; (3) calculate resulting flow rates; (4) calculate pressure residuals at each internal node; and (5) determine whether the maximum of the pressure residuals is lower than a specified tolerance. If the maximum pressure residual is not lower than the specified tolerance then the Wegstein solver may continue by rerun all the branches, with the pressure and flows calculated in items (2) and (3) above to re-estimate the branch resistances. Further, Wegstein acceleration may be applied to the resistances before returning to item (2).

In the example of FIG. 3, the Newton solver 344 can implement a Newton-Raphson technique for solving a system of non-linear equations. The Newton-Raphson technique can be applied iteratively for solving a system of non-linear equations defined by a vector of unknown variables and associated residual equations. Following an initial guess, iterations commence, for example, until one or more criteria are met (e.g., number of iterations, error, etc.). Updates for each iteration of the Newton-Raphson technique may be generated by solving a matrix equation that includes a Jacobian matrix formed by differentiating residual equations with respect to the variables. As an example, an adjustable factor may be used to adjust from a pure Newton-Raphson type of update to another type of update.

The Newton solver 344 includes functionality to solve the oilfield network 302 by implementing the Newton method (e.g., as discussed above). Below is an example of how the Newton solver may be used to solve oilfield network 302.

For solving an oilfield network, a process may include: (1) defining variables and residual equations; (2) determine initial solution; (3) calculating residual and Jacobian matrix for each iteration; (4) solve Jacobian equation for the Newton update; (5) optionally determining adjustment factor; and (6) updating the solution.

With regards to item (1), defining variables and residual equations, branches In an oilfield network may include a number of equipment items. Each branch may be divided into sub-branches with each sub-branch containing a single equipment item. As an example, a new node may be used to join each pair of sub-branches. In this example, primary Newton-Raphson variables can include a flow (Q_{ib}) in each sub-branch in the network and a pressure Pᵢₙ at each node in the network. In this example, temperature (or enthalpy) and composition may be treated as secondary variables.

As an example, residual equations may include a branch residual, an internal node residual, and a boundary condition. In such an example, a branch residual for a sub-branch relates the branch flow to the pressure at the branch inlet node and the pressure at the outlet node. As an example, internal node residuals can define where total flow into a node is equal to total flow out of the node.

As an example, determining an initial solution may be performed using a production model where for each subsequent iteration, a Jacobian matrix is calculated. The values of the Jacobian matrix may be used to solve a Jacobian equation for the Newton-Raphson update. To solve the Jacobian equation, one or more types of matrix solvers may be used.

In the example of FIG. 3, the one or more data sources 306 include one or more types of repositories for data. For example, the one or more data sources 306 may be Internet sources, sources from a company having ties to the oilfield network 302, or any other location in which data may be obtained. The data may include historical data, data collected from other oilfield networks, data collected from the oilfield network being modeled, data describing environmental or operational conditions.

In the example of FIG. 3, the one or more oilfield applications 308 may be applications related to the production of hydrocarbons. The one or more oilfield applications 308 may include functionality to evaluate a formation, manage drilling operations, evaluate seismic data, evaluate workflows in the oilfield, perform simulations, or perform any other oilfield related function. In the example of FIG. 3, the one or more plug-ins 310 may allow integration with packages such as, for example, a TUFPP model, an OLGA™ model, an Infochem Multiflash model (Infochem Computer Services Ltd., London, UK), an equipment model, etc.

While the example of FIG. 3 shows the oilfield production tool 304 as a separate component from the oilfield network 302, the oilfield production tool 304 may alternatively be part of the oilfield network 302. For example, the oilfield production tool 304 may be located at one of the wellsites (e.g., the wellsite 1 312, the wellsite n 314, etc.), at the processing facility 320, or any other location in the oilfield network 302. As another example, the oilfield production tool 304 may exist separate from the oilfield network 302, such as when the oilfield production tool 304 is used to plan the oilfield network.

Various types of numerical solution schemes may be characterized as being explicit or implicit. For example, when a direct computation of dependent variables can be made in terms of known quantities, a scheme may be characterized as explicit. Whereas, when dependent variables are defined by coupled sets of equations, and either a matrix or iterative technique is implemented to obtain a solution, a scheme may be characterized as implicit.

As an example, a scheme may be characterized as adaptive implicit (“AIM”). An AIM scheme may adapt, for example, based on one or more gradients as to one or more variables, properties, etc. of a model. For example, where a model of a subterranean environment includes a region where porosity varies rapidly with respect to one or more physical dimensions (e.g., x, y, or z), a solution for one or more variables in that region may be modeled using an implicit scheme while an overall solution for the model also includes an explicit scheme (e.g., for one or more other regions for the same one or more variables).

As an example of an AIM scheme, consider an AIM scheme available as part of the ECLIPSE™ 300 reservoir simulator marketed by Schlumberger Ltd. (Houston, Tex.). The ECLIPSE™ 300 reservoir simulator may implement a fully implicit scheme or an implicit-explicit scheme that is implicit in pressure and explicit in saturation, known as IMPES. In the fully implicit scheme, values for both pressure and saturation are provided at the end of each simulation time-step; whereas, the IMPES scheme uses saturation values from the beginning of the time-step to solve for pressure values at the end of the time-step. In such examples, a reservoir simulator iterates until pressures values in grid blocks of a model of the reservoir being simulated have reached some internally consistent solution. However, a solution may be difficult to find if saturation (which the IMPES scheme assumes is constant within a time-step) changes rapidly during that time-step (e.g., a large percentage change in grid block values for saturation). The IMPES scheme may be able to cope with such an issue by decreasing “length” (e.g., duration) of the time-step but at the cost of more time-steps (e.g., in an effort to achieve a more stable solution).

The aforementioned fully implicit scheme may be a more stable option with saturation and pressure being obtained simultaneously so as any difference between their values for one time-step and a next time-step does not disturb a solution process as much as when compared to the IMPES scheme. Thus, in a fully implicit scheme, the “length” (e.g., duration) of a time-step may be larger but it also means that the fully implicit scheme may take additional processing time to achieve solutions (e.g., in comparison with an IMPES scheme). However, in a reservoir where properties change rapidly, a fully implicit scheme may provide a solution in less computational time than an IMPES scheme, even though an iteration of the fully implicit scheme may take longer to complete when compared to an iteration of the IMPES scheme.

The aforementioned ECLIPSE™ 300 reservoir simulator may also implement one or more modules such as a black-oil simulator module, a compositional simulator module, or a thermal simulator module. As an example, a black-oil simulator module may include equations to model three fluid phases (e.g., oil, water, and gas, with gas dissolving in oil and oil vaporizing in gas); as an example, a compositional simulator module may include equations to model phase behavior and compositional changes; and, as an example, a thermal simulator module may include equations to model a thermal recovery processes such as steam-assisted gravity drainage (SAGD), cyclic stream operations, in-situ combustion, heater, and cold heavy oil production with sand.

As to network models, as an example, a method can include simulation of steady state operation of an oil and gas production system over various ranges of operating conditions and configurations. In such an example, the method may include an implicit evaluation of conservation of energy equations in addition to mass and momentum as an effective technique for efficiently and robustly simulating the production system where, for example, the production system includes fluid such as heavy oil, steam or other fluids at or near critical pressures or temperatures. The term “critical point” is sometimes used herein to specifically denote a vapor-liquid critical point of a material, above which distinct liquid and gas phases do not exist.

As mentioned, a production system can provide for transportation of oil and gas fluids from well locations along flowlines which are interconnected at junctions to combine fluids from many wells for delivery to a processing facility. Along these flowlines (including at one or more ends of a flowline), production equipment may be inserted to modify the flowing characteristics like flow rate, pressure, composition and temperature. As an example, a boundary condition may depend on a type of equipment, operation of a piece of equipment, etc.

As an example, a simulation may be performed using one type of equipment along a flowline and another simulation may be performed using another type of equipment along the same flowline, for example, to determine which type of equipment may be selected for installation in a production system.

As an example, a simulation may be performed using one type of equipment at a position (e.g., with respect to a flowline) and another simulation may be performed using another type of equipment at a different position (e.g., with respect to the same flowline or a different flowline), for example, to determine which type of equipment may be selected for installation in a production system as well as to determine where a type of equipment may be installed. As an example, a simulation may be performed using one type of equipment at a position (e.g., with respect to a flowline) and another simulation may be performed using that type of equipment at a different position (e.g., with respect to the same flowline or a different flowline), for example, to determine where that type of equipment may be installed.

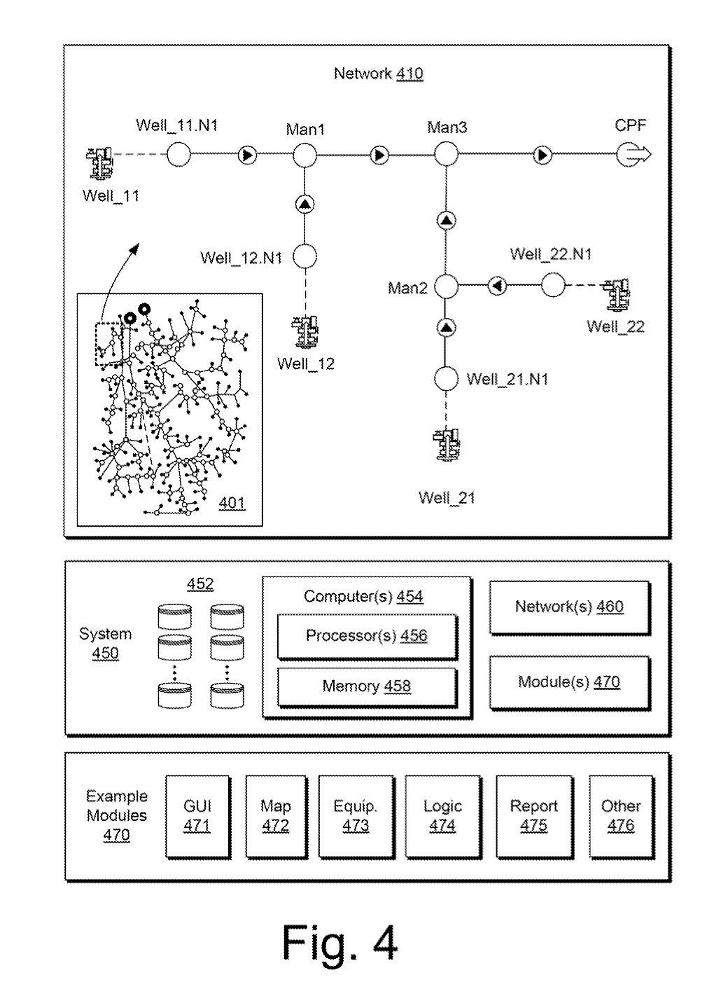

FIG. 4 shows an example of a relatively small production system network 410 (e.g., optionally a portion of a larger network 401), an example of a system 450 and examples of modules 470. As shown, the network 410 forms somewhat of a tree like structure where flowlines represent branches (e.g., segments) and junctions represent nodes. As shown in FIG. 4, the network 410 provides for transportation of oil and gas fluids from well locations along flowlines interconnected at junctions with final delivery at a central processing facility.

Given information of operating condition(s) at boundary nodes (e.g., where fluid enters and exists the system) and the physical environment between them (e.g., geographical location, elevation, ambient temperature, etc.), a production engineer may aim to design a production system that meets business and regulatory requirements constrained to operating limits of available equipment.

As an example, a method can include implementing one or more modules to simulate steady state operation of a production system, for example, as including a network (e.g., as a sub-network, etc.) as in the example of FIG. 4 (also see, e.g., FIG. 1). Such a method may include simulating the steady state operation over a selected range of operating conditions and configurations (e.g., optionally a broadest reasonable range).

An example is provided below as to equations that may be formulated to model a network and to simulate operation of a production system represented by the network.

Consider a network with n_{N} nodes and n_{B} branches as depicted in FIG. 4. Among the n_{N} nodes, there are n_{IN} internal nodes and n_{BN} boundary nodes. A method can include indexing internal nodes with indices i, i=1, . . . , n_{IN}, branches with j, j=1, . . . , n_{B}, and boundary node with k, k=n_{IN}+1, . . . , n_{N}. Such a method can include letting V_{I} denote the set of internal nodes, and V_{B} denote the set of boundary nodes. For example, a method can include letting V=V_{I}∪V_{B} to denote a set of nodes. Further, such a method can include letting A denote the set of branches. By topology of the network 410, it is also possible to define a set of maps that relate the branches to the nodes. For example, let φⱼ denote the map from the branch index j to its inlet node index a; let φ_{O} denote the map from the branch index j to its outlet node index b; let φ_{S} denote the map from the branch index j to its geometric start node index s; let φ_{E} denote the map from the branch index j to its geometric end node index e: and let φ_{J} denote the map from a node index b to the set of its connected branches, i.e., φ_{J}(b)={j:φ_{I}(j)=b or φ_{O}(j)=b}. Note, as an example, geometric start and end nodes may not necessarily correspond to the inlet and outlet nodes. For example, in a case where they flip, the flow rate Qⱼ in that branch can be negative.

To model the network 410, a set of equations can include terms for conservation of momentum, conservation of mass and conservation of energy. A set of implicit variables may be formulated, for example, where the following are implicit: pressure P at each node, flow rate Q in each branch and temperature T at each node. In such an example, two intermediate variables may be defined as follows: composition C as a function of Q and enthalpy H as a function of P and T.

As an example, an approach that provides flexibility as to treatment of enthalpy/temperature as implicit variables may optionally be applied in situations where, for example, one or more fluids such as heavy oil, water, steam, etc. are present and, for example, where pressure/temperature for one or more fluids are near a critical point (e.g., a vapor-liquid critical point of fluid, above which distinct liquid and gas phases do not exist). To provide enthalpy/temperature flexibility, conservation equations ay be defined (e.g., for a Jacobian matrix).

As an example, equipment may be modeled as being adiabatic (e.g., adiabatic devices), for example, on the basis that equipment lengths are substantially smaller than pipe lengths and that heat loss over such equipment can be suitably considered as being negligible. However, for compressors and pumps, a formulation can optionally consider heat gain as a result of loss of total efficiency (e.g., based on manufacturer specifications for efficiency with respect to operational conditions, etc.).

As an example, for instances without an explicit formula for change of enthalpy with respect for pressure and temperature, it is possible to implement one or more flash algorithms provided as a package or packages, for example, to calculate numerical derivatives. As an example, a formulation and solution process may include implementing one or more flash packages that include features to calculate one or more analytical derivatives.

Production systems provide for transportation of oil and gas fluids from well locations to processing facilities and represent a substantial investment in infrastructure with both economic and environmental impact. Simulation of such systems, which may include hundreds or thousands of flow lines and production equipment interconnected at junctions to form a network, can be complex and involve multiphase flow science and engineering and mathematical methods to provide solutions (e.g., by solving large systems of non-linear equations). Factors associated with solid formation, corrosion and erosion, and environmental impact may increase complexity and cost.

As an example, a framework may implement an approach that includes a network layer and a branch layer. As an example, a framework may implement another approach, which may be referred to as a “uni-layer” approach. For example, given a flow network to solve, a framework may receive input that models the flow network for assessment using a network simulator. In such an example, the network simulator may include a layer, for example, defined without specifying a network layer and a branch layer (e.g., without a branch concept and where equipment may be directly exposed). In such an example, a model of a network may include constructs for equipment such as, for example, compressors, sources, sinks, connected flowlines, junctions, etc. where such constructs may represent physical and/or virtual junction points. Such a model may account for equipment that may be unidirection, bidirectional, directionless and/or having an explicit branch boundary (e.g., consider a well).

As an example, a bidirectional piece of equipment can be specified to include a first selectable direction and a second selectable direction (e.g., in terms of a hierarchy). In such an example, when flowing in the first selectable direction, the piece of equipment may have a given behavior that may differ from a given behavior in the second selectable direction (e.g., opposite or reverse to the first selectable direction). As an example, a manifold may provide for splitting its input into a plurality of branches. In such an example, there is a direction (e.g., input to outputs) that causes flow in a forward direction to be divided into the plurality of branches. However, when flow is in an opposite (e.g., reverse) direction, the plurality of branches may serve as inputs and the manifold may aggregate the individual flows of the plurality of branches to an output. As an example, an unidirectional piece of equipment is a piece of equipment that is specified to flow in a particular direction (e.g., a forward direction where flow in a reverse direction is prohibited). As an example, a directionless piece of equipment may be specified to allow for flow in multiple directions, for example, without alteration of behavior.

As shown in FIG. 4, the system 450 includes one or more information storage devices 452, one or more computers 454, one or more networks 460 and one or more modules 470. As to the one or more computers 454, each computer may include one or more processors (e.g., or processing cores) 456 and memory 458 for storing instructions (e.g., modules), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 452.

As an example, the one or more modules 470 may include instructions (e.g., stored in memory) executable by one or more processors to instruct the system 450 to perform various actions. As an example, the system 450 may be configured such that the one or more modules 470 provide for establishing a framework, for example, that can perform network modeling. As an example, one or more methods, techniques, etc. may be performed using one or more modules, which may be, for example, one or more of the one or more modules 470 of FIG. 4.

FIG. 4 shows example modules 470 as including a graphical user interface (GUI) module 471, a map module 472, an equipment module 473, a logic module 474 (e.g., for formulating one or more functions, which may be subject to one or more constraints, etc.), a report module 475 and one or more other modules 476.

As an example, one or more modules may include instructions to instruct a system to render terrain and equipment locations to a display (e.g., via the GUI module 471, the map module 472, the equipment module 473, etc.); assign one or more domain constraints (e.g., via the logic module 474); analyze an objective function associated with the terrain and the equipment locations subject to at least one of the one or more domain constraints (e.g., via the logic module 474); and render information to the display based at least in part on an analysis of the objective function (e.g. via the GUI module 471, the report module 475, etc.).

As an example, a domain constraint may be a constraint that mathematically constrains a domain or domains that form, for example, a solution space or spaces. For example, constraints may define in part a solution space where a solution may exist for a given objective function. As an example, consider a linear programming optimization problem that includes an objective function and a polytope defined by constraints (e.g., equalities, inequalities, etc.). A solution to the problem may exist on the polytope that minimizes the objective function (e.g., the shape of a polytope may be defined by constraints that are applied to an objective function).

As an example, a method may implement an optimization process that may including finding a set of values for an objective function given a defined domain (e.g., defined by a set of constraints), finding sets of values for objective functions given defined domains, etc. In such an example, a set of values may provide an optimal solution that, for example, may minimize or maximize an objective function.

As an example, an objective function may be a mathematical function that describes a quantity or quantities to optimize and domain constraint may restriction a solution space, for example, by quantifying regions, conditions, etc. to be avoided (e.g., avoidance areas, number of river crossings, assurance of flow such as risk of hydrate formation, wax build-up, etc.). As an example, a problem may be formulated in terms of functions of flow path (e.g., terrain), environment, equipment locations, etc. A solution to a problem (e.g., a set of values for an objective function) may or may not be constrained by one or more constraints (e.g., the values may lie within a region of a domain that is not directly bound by a particular constraint or constraints).

As an example, a framework may be implemented using various features of a system such as, for example, the system 450 of FIG. 4. As an example, one or more modules may be provided that include instructions that may be executed by a processor or processors. As an example, instructions may be provided for execution of instructions in parallel, for example, to consider multiple features of a network or networks that may be associated with a geologic environment such as the geologic environment 110 of FIG. 1.

As an example, a method may include implementing automated production design and a monitoring assistant, for example, which may help to alleviate various tasks in a design process while considering prioritized constraints and providing guidance on potential hotspots (e.g. and optionally best approaches, knowledge sharing, etc.).

As an example, a system for simulation, design and monitoring of a production system may include one or more modules for:

Environmental constraints, terrain effects, etc., for example, by leveraging an integrated digital geographic system;

Optimization constraints such as, for example, maximum flow rate, max gas produced, maximum erosion, etc.;

Identification of potential issues based on a set of rules;

Automatic adaptive reporting, for example, with focus and details generated for an area of interest or hotspots based on a predefined set of rules; and

Capture of actions performed by a user and statistical analysis of those actions to guide a new user based on those actions as well as the user current context.

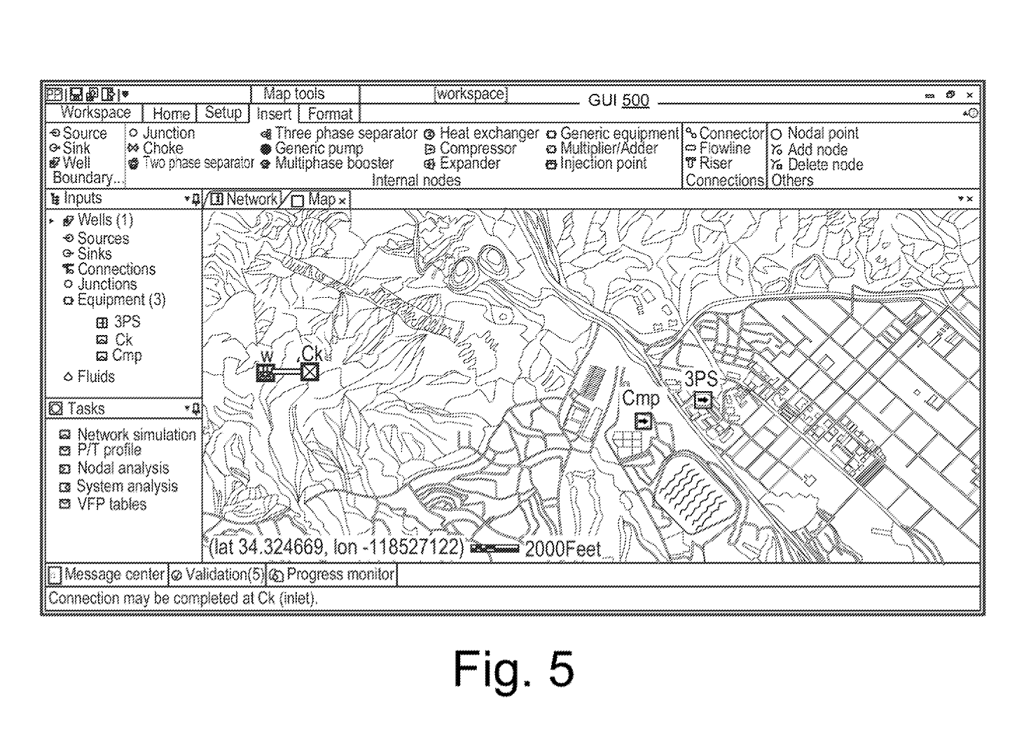

FIGS. 5 to 9 show some examples of graphical user interfaces (GUIs) 500, 600, 700, 800 and 900 that may be rendered to a display to present information (e.g., and to facilitate user interaction). As an example, a system may include modules for rendering such GUIs to a display, a screen, etc. (e.g., whether local, remote, local and remote, touch, etc.). As an example, rendering may occur via one or more processors (e.g., optionally one or more GPUs, etc.) where information may be transmitted to a display, a projector, a network, a printer, etc. In such an example, at least a portion of the information may be for creating a visual (e.g., on a display, on a screen, via a printer, etc.). As an example, a method may include rendering information where such rendering may occur at least in part via execution of one or more modules such as, for example, one or more graphics modules (e.g., consider OpenGL, Direct3D, etc.). As an example, a method that includes rendering may include rendering information such as image (e.g., picture, etc.) information, vector information, text information, etc.

As an example, a workflow may include tasks that may be performed at least in part via a system where the system may include a processor and memory accessible by the processor where instructions stored in the memory may instruct the processor to call for rendering of information to a display. As an example, a workflow may be described with respect to the GUIs 500, 600, 700 and 800 of FIGS. 5 to 8. Below, various features of the GUIs 500, 600, 700 and 800 are described followed by an example of a workflow.

As an example, to design a production and transportation system, a designer may have a certain amount of information available such as, for example, location of wells, location of some facilities, etc. The designer may also have a certain number of constraints like the cost, restricted areas for environmental concerns, erosion rate of pipeline material, max rate of solid deposition, etc. A designer may aim to design a system that is reliable yet within a desired cost range and that may meet one or more other constraints. A designer may be interested in knowing “weak points” of a production system, for example, to know what should be monitored and which preventive actions may be prescribed and optionally taken.

As an example of a system capability, consider the GUI 500 of FIG. 5 where an integrated digital geographic system may assist a user as to locating some known equipment (e.g., wells, already existing pipelines, etc.). In the example GUI 500, icons are shown with respect to a satellite view of terrain along with man-made structures.

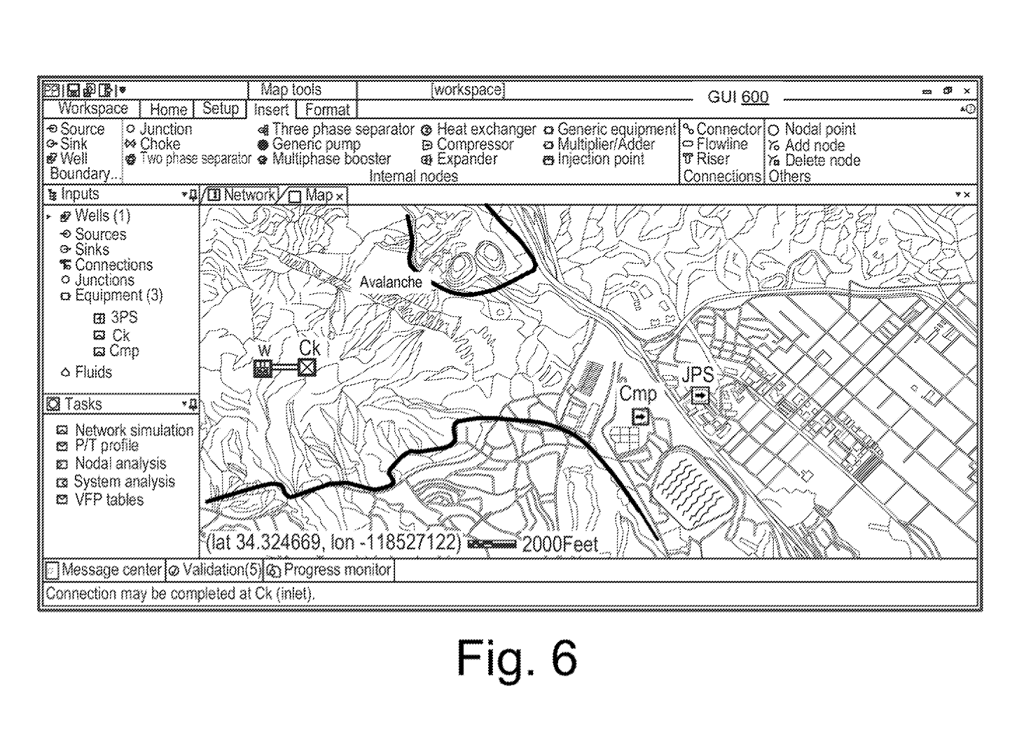

As an example of a system capability, consider the GUI 600 of FIG. 6, where the user may then define one or more additional constraints like avoidance zones, maximum terrain slope, etc. (e.g., see curves that bound particular features shown in the view of the terrain). A user may also define which equipment may be optimally connected, for example, based on one or more imposed constraints. As an example, equipment may be selected and illustrated as being associated via a line, a curve, highlighting, etc. (see, e.g., “SmartConnect” functionality).

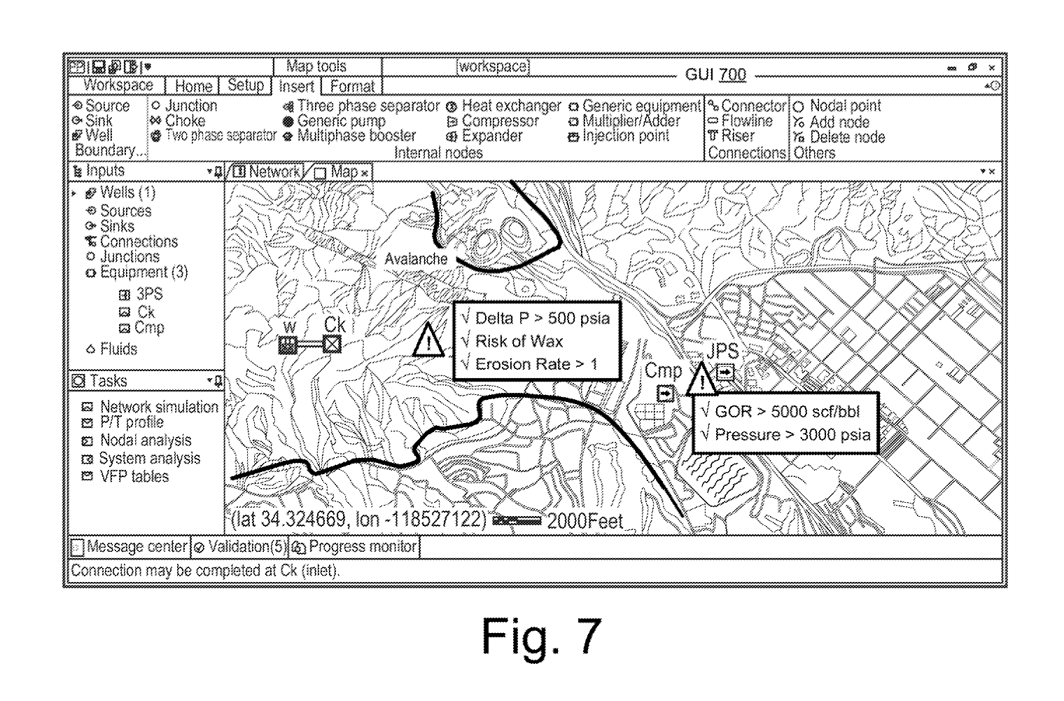

As illustrated with respect to the example GUI 700 of FIG. 7, a system capability may allow the user to then define one or more reporting criteria such as, for example, pressure difference (Delta P), erosion rate, etc. which may be used to define one or more zones of interest/hot spots for reporting and reporting details (e.g., as generated by a reporting module). Specifically, the GUI 700 of FIG. 7 shows triangles with exclamation points as markers with additional information such as information associated with pressure, risk of wax, erosion rate, GOR, etc. (see, e.g., “SmartReporting” functionality). Further, particular pieces of equipment are represented as icons, which may optionally be positionable via the GUI 700 to update an assessment (e.g., with associated constraints, costs of new equipment, repositioning the equipment, etc.).

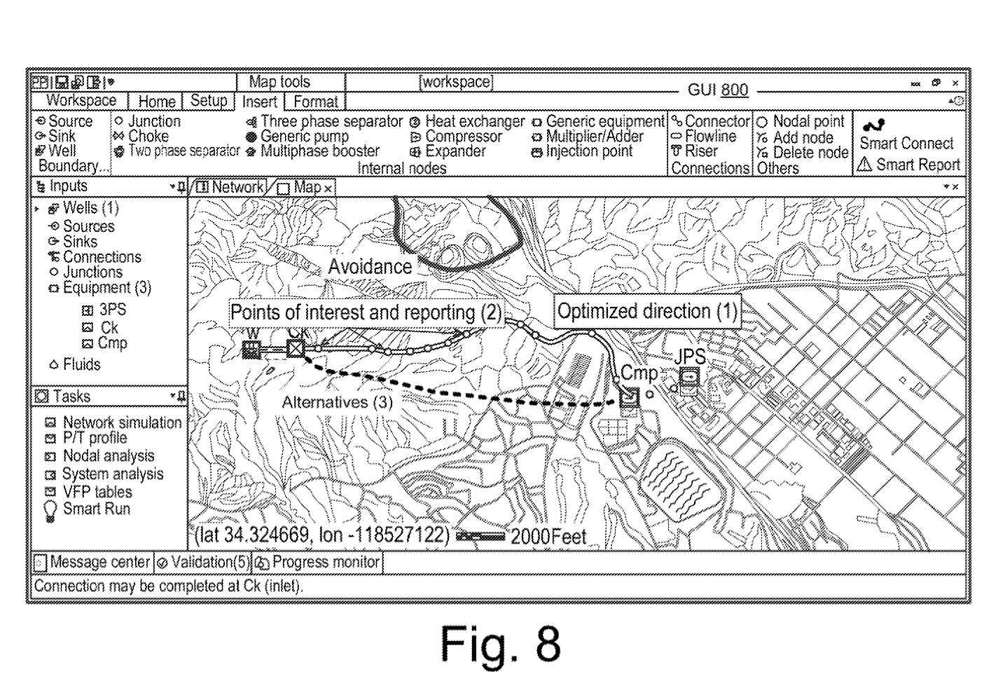

As an example of a system capability, consider the GUI 800 of FIG. 8, which shows various GUI elements (1, 2 and 3) with respect to the terrain, equipment, etc. In such an example, the user may run a defined problem (see, e.g., “SmartRun” functionality) and the system will provide a solution, for example, as to optimized location(s)/connection(s) of equipment (see, e.g., element 1) with some alternatives solutions (see, e.g., element 3). A solution may also be reported graphically at a high level, for example, for an overall condition of the optimized system with more details automatically provided around the areas of interest (see, e.g., element 2).

As an example, one or more GUIs may provide a user with interactive capabilities where computational resources operate in real-time (e.g., or near real-time) to allow a user to graphically interact with an optimized solution, for example, to see how one or more changes may impact an overall solution. For example, a user may drag slightly a modified solution toward an alternative solution to see the impact on cost. As an example, the interaction process may change a model and, for example, trigger a simulation service to call for a simulation or simulations using change information associated with the change (e.g., consider a simulation service configured to communicate with one or more simulation engines, etc.).

As an example, a workflow may include rendering a GUI such as the GUI 500 of FIG. 5. In such an example, a user may navigate the GUI 500 where a system receives commands responsive to user interactions of the GUI 500. For example, the GUI 500 includes graphic controls associated with equipment and includes a panel for rendering of equipment, for example, with positions that are associated with map information (e.g., GIS information, etc.).

In the example of FIG. 5, the GUI 500 illustrates a well and three associated pieces of equipment where each piece of equipment has an associated position. As an example, a workflow may include determining a path for connecting equipment. For example, a workflow may aim to determine a path that connects at least two pieces of the equipment of the GUI 500 of FIG. 5. In such an example, a system may be instructed as part of a workflow to determine one or more paths that connect the choke (Ck) to the compressor (Cmp). For example, the system may include information as to chokes and information as to compressors where the choke (Ck) may be specified to be a particular choke or to be a choke within a particular range of choke specification parameters and where the compressor (Cmp) may be specified to be a particular compressor or to be a compressor with a particular range of compressor specification parameters.

As an example, a system may determine one or more paths that connect at least two pieces of equipment with some amount of slack, which may be slack that is bound at least in part by one or more equipment specification parameters. In such an example, an output of the system may be: “path Y is optimal if compressor is upgraded to Z horsepower” (e.g., where the upgrade is within a range of equipment specification parameters). Such an output may be based in part on an objective function that can be bifurcated based at least in part on options with respect to one or more pieces of equipment.

As an example, a workflow may progress from one task to another task. In such an example, a system may call for rendering information to a GUI. For example, a workflow may progress from the GUI 500 of FIG. 5 to the GUI 600 of FIG. 6.

As an example, a user may define a logical connection or connections via interacting with a GUI such as the GUI 600 of FIG. 6. For example, a user may interact with an input mechanism of a system to cause the system to receive instructions as to how two or more pieces of equipment are to be connected. In such an example, the instructions may provide conceptual input to the system, for example, conceptual specifications that may be included in one or more objective functions that may be implemented by the system to determine one or more paths between the pieces of equipment.

As an example, a workflow may include defining one or more avoidance zones. For example, in the GUI 600 of FIG. 6, a user may select one or more controls for constructing a zone or zones. As shown, an avalanche zone exists about a region with an increased elevation. Such a zone may be input by a user and/or determined based on data accessible by a system. For example, where an avalanche control exists, upon selection of the control, a system may search one or more databases for information as to avalanches. As an example, a database may be one or more of a news service database, an engineering database, an insurance database, a geological survey database, etc. In such an example, the system may render information to a GUI to illustrate to a user where avalanche risks exist.

As an example, a GUI may code avalanche information as to severity, time windows, environment conditions (e.g., weather, etc.), etc. For example, a red line may indicate a higher risk and a yellow line a lower risk. As an example, a GUI may render month or months with greater avalanche risk (e.g., February and March). While avalanche is mentioned, which may pertain to snow and ice, a system may indicate risk of mudslides, rockslides, etc. As an example, a system may access and render information and/or controls as to mitigation of avalanche risk, mudslide risk, rockslide risk, etc. For example, where a risk exists, a GUI may render a menu that includes options for mitigation where a user may select one or more options. In such an example, an objective function may be modified to account for one or more mitigation options. As an example, an option for a snow and ice avalanche may be to dispose a portion of a pipeline in a trench; whereas, an option for a rockslide may be to modify a region to reduce risk of rock impacting a pipeline. As to a mudslide, an option may be to construct a sluice to direct water away from a region susceptible to mudslides.

As an example, a workflow may progress from a task or tasks associated with the GUI 600 of FIG. 6 to a task or tasks associated with the GUI 700 of FIG. 7. For example, a workflow may include defining an object function.

As an example, a system may render the GUI 700 to a display and a user may interact with one or more controls of the GUI 700 to define, at least in part, an objective function. As an example, an objective function may be formulated for purposes of minimizing one or more of cost of a pipeline, a terrain effect, etc. As mentioned, factors such as avoidances may be represented in an objective function or objective functions, for example, as one or more constraints. For example, a user may interact with a GUI to identify factors and a system may convert such identified factors into one or more constraints of one or more objective functions.

As an example, factors that may define constraints may include, for example, maximum erosional velocity at one or more points in a network, a flowline constraint, a maximum GOR, etc. As an example, a system may link factors (e.g., and associated constraints) to reporting. For example, imposed constraints may define a report type, which may be output by a system (e.g., to a display, a printer, an email, etc.).

As an example, a system may decouple one or more report constraints from one or more domain constraint. In such an example, a user may specify a constraint and a margin where a report may be produced if the margin is reached and where the constraint is not violated.

As an example, a system may remove a constraint from a report or add to a report a threshold, which may not correspond to a defined objective function constrain. In such an example, constraints may be set at an objective function level and at a report level.

As an example, a default configuration or preset configurations may be available, for example, in terms of objective functions, constraints, etc. In such an example, a system may present various options via a GUI where one or more controls allow a user to select one or more of the options via an input mechanism (e.g., a mouse, a touch-screen, voice, etc.).

As an example, a workflow may progress from a task associated with a GUI such as the GUI 700 of FIG. 7 to a task associated with a GUI such as the GUI 800 of FIG. 8. For example, after one or more objective functions have been formulated for a scenario, a system may render a GUI that includes an option to analyze the one or more objective functions to determine one or more paths that connect specified pieces of equipment in a network.

As an example, an analysis performed by a system may issue one or more instructions that call for rendering of information to a display, optionally during the analysis. For example, a system may call for one or more visual cues to indicate where “hotspots” may exist. For example, a hotspot may be a location associated with a condition or conditions that may violate one or more constraints. In such a system, where a constraint is violated, a user may be automatically alerted (e.g., consider rendering of a red hotspot, etc.) via a GUI. In such an example, the GUI may include a control for generation, display, etc. of a report for the hotspot (e.g., for one or more conditions, etc. at a location). For example, a GUI may include a hover control whereby a user may navigate a cursor, hold a finger, a stylus, etc. over a hotspot to thereby instruct the system to render a control for a report or reports. As an example, a report may be a summary report that is sized for display in a GUI without obscuring various portions of a network (e.g., where a user may see the summary report and various portions of a network, an environment, etc. that may be associated with a hotspot). As an example, where a reporting threshold is reached (e.g., a report constraint) but an domain constraint is not violated, a system may call for rendering a graphic that may be coded to indicate the logic thereof. For example, where a report constraint and an domain constraint are violated, a red hotspot may be rendered to a display; whereas, where a report constraint is violated and an domain constraint is not violated, a yellow hotspot may be presented. As an example, a system may present one or more options that may mitigate, address, etc., violation of one or more constraints. Where an option is selected, a system may modify a report constraint and/or an domain constraint in response to receipt of the selection.

As an example, a workflow may include a system rendering a set of equipment with known positions and places for the set of equipment on a map canvas, defining one or more logical connections between two or more pieces of the equipment, defining one or more avoidance zones, defining an objective function, defining one or more domain constraints (e.g., optionally constraints additional to those defined by equipment, logical connections, avoidance zones, etc.), optionally defining one or more report constraints, and solving the objective function subject to the domain constraints. In such an example, the system may include reporting one or more violations to a constraint or constraints (e.g., objective function, report, etc.).

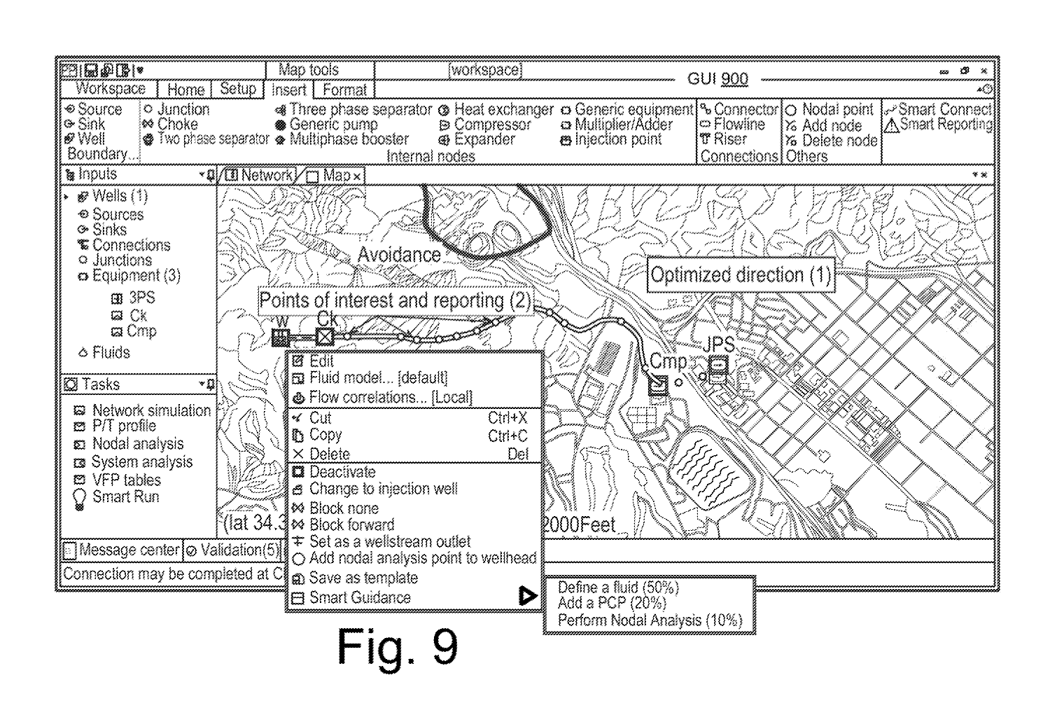

In the example GUI 900 of FIG. 9, a system may include capabilities to allow for feedback, training, etc. For example, a feedback tool module may guide a user as a trainer or advisor by helping the user design a system. As an example, a system may collect statistics on usage patterns in a given context. For example, when users insert a well at a given location, the next step they generally perform is to define a fluid. The statistics collection may be performed locally for a given machine or in a distributed manner allowing the user to participate in a knowledge or user community, for example, where statistics are aggregated at a higher group level to provide more reliable patterns. As an example, where a training mode is activated, a system may recognize the context of a user (e.g., a well is selected for example) and then will propose a set of actions based on the statistics collected from previous users/usages. As shown in the example GUI 900 of FIG. 9, various actions are shown in one or more panels (see, e.g., “SmartGuidance” functionality) that correspond to a user selecting a well (e.g., a well selection context).

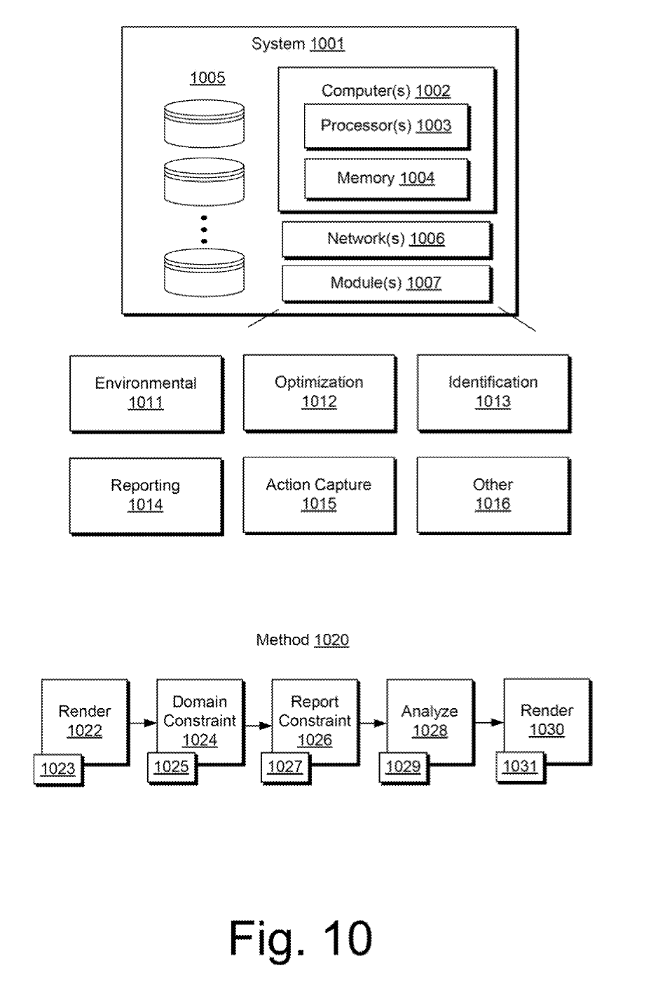

FIG. 10 shows an example of a system 1001 and a method 1020. As shown in FIG. 10, the system 1001 includes one or more computers 1002, one or more storage devices 1005, one or more networks 1006 and one or more modules 1007. As to the one or more computers 1002, each computer may include one or more processors (e.g., or processing cores) 1003 and memory 1004 for storing instructions (e.g., modules), for example, executable by at least one of the one or more processors. As an example, a computer may include one or more network interfaces (e.g., wired or wireless), one or more graphics cards, a display interface (e.g., wired or wireless), etc. As an example, data may be provided in the storage device(s) 1005 where the computer(s) 1002 may access the data via the network(s) 1006 and process the data via the module(s) 1007, for example, as stored in the memory 1004 and executed by the processor(s) 1003.

FIG. 10 also shows some examples of modules such as an environmental module 1011 (e.g., for environmental constraints, terrain effects, etc., for example, by leveraging an integrated digital geographic system), an optimization module 1012 (e.g., for optimization constraints such as, for example, maximum flow rate, max gas produced, maximum erosion, etc.), an identification module 1013 (e.g., for identification of potential issues based on a set of rules), a reporting module 1014 (e.g., for adaptive reporting, for example, with focus and details generated for an area of interest or hotspots based on a predefined set of rules), an action capture module 1015 (e.g., to capture actions performed by a user and statistical analysis of those actions to guide a new user based on those actions as well as the user current context), and one or more other modules 1016.

The method 1020 of FIG. 10 includes a render block 1022 for rendering a terrain and locations of equipment to a display, a constraint block 1024 for assigning one or more domain constraints, a constraint block 1026 for assigning one or more report constraints, and an analysis block 1028 for analyzing at least one objective function associated with the terrain and the equipment subject to at least one of the constraints. Such a method may further include rendering information to the display in response to the analyzing, for example, based at least in part on at least one of the one or more report constraints (see, e.g., render block 1030).

The method 1020 is shown in FIG. 10 in association with various computer-readable media (CRM) blocks 1023, 1025, 1027, 1029 and 1031. Such blocks (e.g., modules) generally include instructions suitable for execution by one or more processors (or processing cores) to instruct a computing device or system to perform one or more actions. While various blocks are shown, a single medium may be configured with instructions to allow for, at least in part, performance of various actions of the method 1020. As an example, a computer-readable medium (CRM) may be a computer-readable storage medium. As an example, one or more of the blocks 1023, 1025, 1027, 1029 and 1031 may be provided as one or more modules (see, e.g., the module(s) 1007) that are executable by a system such as the system 1001.

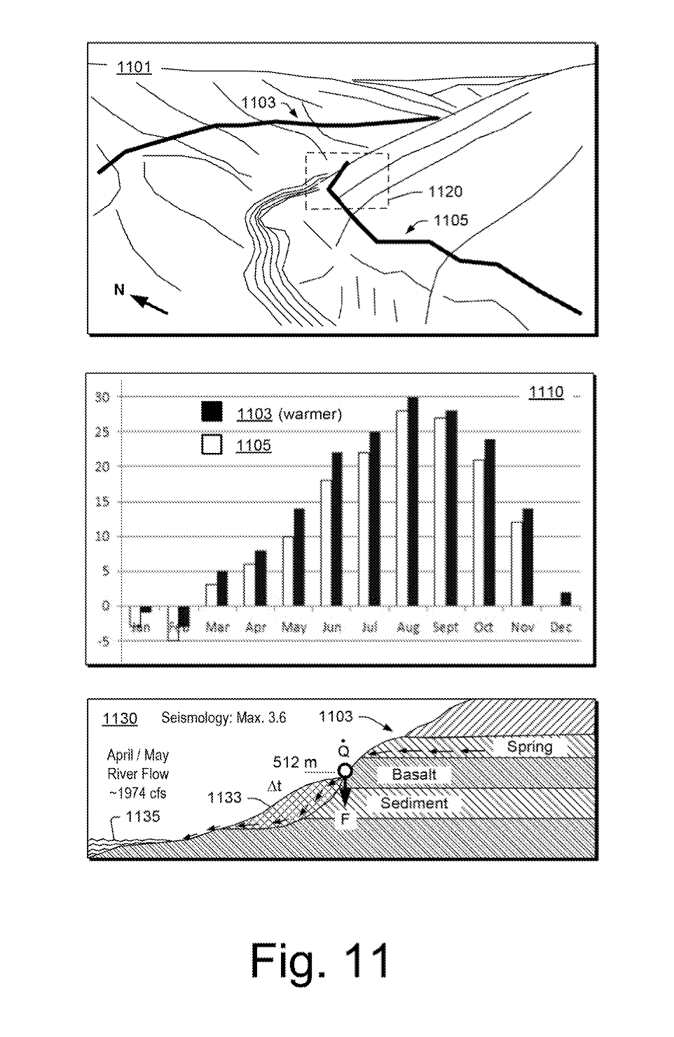

FIG. 11 shows an example of a scenario 1101 that includes two paths 1103 and 1105 that follow terrain. In the example of FIG. 11, a compass direction is indicated (see, e.g., arrow indicating north). Thus, the paths 1103 and 1105 may be defined to be a northerly path 1103 and a southerly path 1105. Given the topography illustrated, the northerly path 1103 may receive more sunlight than the southerly path 1105. In such an example, temperature data may be provided for one or more portions of each of the paths. As shown in a plot, the temperatures of the northerly path 1103 may exceed (e.g., on average, etc.) the temperatures of the southerly path 1105. Such data may be input to a system, for example, to calculate factors such as heat transfer and possible consequences thereof (e.g., phase change, viscosity, solubility, etc.).

As an example, the scenario 1101 may be rendered as a GUI. In such an example, a window may be sized to include one or more paths. For example, a window 1120 is shown that includes a portion of the path 1105. The window 1120 may select information for rendering in a cross-section or other view such as the view 1130. Such a view may allow a user to assess various factors that may be germane to a path of a network.

As shown in the example of FIG. 11, for the scenario 1101, the window 1120 illustrates various features of the topography and information associated therewith. For example, a portion of a path may be associated with lithology data, which may provide insight as to geomechanics, flow paths, etc. For example, the southerly path 1105 may be supported by terrain that includes a basalt layer and a sedimentary formation layer, which may be of lesser structural integrity than the basalt layer. Further, one or more natural springs may exist, which may be seasonal. Also shown in FIG. 11 are data pertaining to seismic history (e.g., seismic risk), seasonal volumetric flow of a waterway (see, e.g., a waterway 1135), elevation, etc. In such an example, one or more of the indicated factors may be input to a system, for example, to determine one or more constraints which may be germane to pipeline stability, pipeline leakage risk, residence time of a formation with respect to fluid that might flow from a leaking pipeline (see, e.g., a formation 1133), paths to a waterway (see, e.g., the waterway 1135), seismic risk, etc. As an example, a scenario may account for structural engineering related factors and, for example, environmental risks.

As an example, fluid properties of fluid being transported, handled by equipment, etc. may include phase splits, density, viscosity, etc., which may be functions of, for example, in situ pressure and enthalpy. As an example, a system may account for how pressure and enthalpy are affected by terrain, for example, due to pressure loss, ambient temperature, etc.

As an example, a system may account for terrain properties such as, for example, geomechanical properties, hydrodynamic properties, etc. For example, terrain properties may be taken into account with respect to structural engineering of a pipeline, an equipment foundation, etc. As an example, a system may account for combined risk factors, such as, for example, movement of terrain (e.g., compaction, sliding, shaking, etc.), which may be in part due to structural engineering design (e.g., drilling, movement of vehicles, etc.). As an example, consider a risk analysis that considers movement of terrain that may cause displacement of a pipeline where such displacement may potentially result in leakage of fluid from the pipeline. In such an example, terrain factors and fluid properties may be inputs that can determine how leaking fluid may pool, flow, etc. As an example, a system may include a module that can account for a variety of factors to determine how leaking fluid may drain, mix with rain or other water runoff, percolate, etc. In such an example, sources of water in a terrain may be taken into account (e.g., springs, streams, lakes, water reservoirs, etc.). As an example, an analysis may give rise to one or more constraints such that a particular area of terrain is to be avoided due to one or more risks. As an example, a risk or risks may be associated with a lifecycle and may occur, increase, decrease, etc. with respect to time. Thus, as an example, where a lifecycle for a possible path is considered, a risk or risks may be determined as being associated with one or more times during the lifecycle. In such an example, a system may provide one or more recommendations to account for a risk or risks, which may include one or more time-based recommendations (e.g., at time t1, reinforce foundation of pipeline at region X; at time t2, rebuild sluice at region Y, etc.).

As an example, window 1120 may be a GUI that includes one or more interactive controls. For example, a user may click on a feature and, in response to receipt of a click signal as input, a system may render information (e.g., a menu, parameter values, etc.) to the GUI.

As an example, elevations of a path may be considered by a system to calculate potential energy. As an example, a Bernoulli equation may be implemented by a system, which may optionally account for compressible flow (e.g., for gas, multiphase fluid, etc.). As an example, where a path includes a drop in elevation that may allow for energy scavenging from flowing fluid, an option may exist for installation of energy scavenging equipment. In such an example, the energy scavenging equipment may include one or more sensors and/or may be operatively coupled to one or more sensors. As such, a system may provide options for instrumentation of a path, which may optionally be included in an objective function. For example, consider a system that can lower objective function value as part of a path optimization scheme by including one or more remote sensors that may derive power via energy scavenging.

As another example of a power source, consider a system that may calculate sun exposure with respect to one or more types of solar collectors. For example, a system may include a listing of types of equipment and associated power requirements. Where a portion of a path is exposed to sunlight sufficient to power a piece of equipment (e.g., via solar cells, etc.), a system may indicate such a portion or portions. For example, a menu option may exist in a GUI to indicate sun exposure values (e.g., daily energy, weekly energy, etc.). As an example, a system may consider specifications for one or more energy storage devices. For example, where solar cells may generate energy via sun exposure, a battery may be presented as an option. In such an example, for a particular type of equipment, the system may indicate operational conditions for that equipment as powered by the battery as charged by the solar cells. As an example, consider a system that can indicate that flow meter may be operable for 2 hours per week given sun exposure, solar cell energy and battery power storage. Such an indication may account for wireless transmission of the flow meter, for example, using one or more types of communication circuitry (e.g., cellular circuitry, etc.).

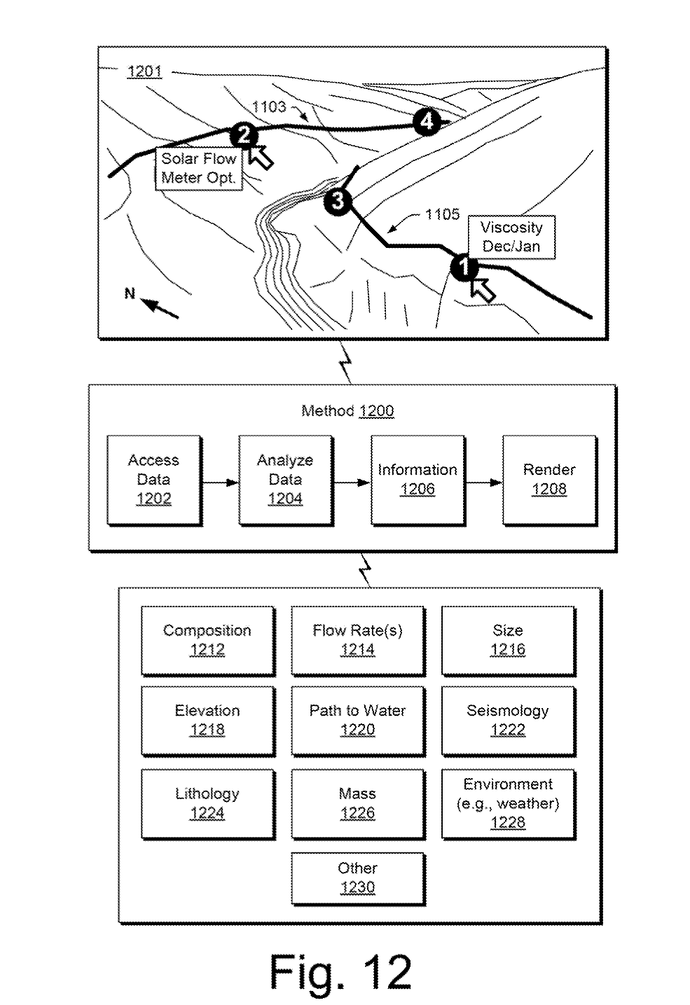

FIG. 12 shows the scenario 1101 of FIG. 11 in the form of a GUI 1201 together with examples information that may be rendered to a display where the information pertains to the path 1103 and/or the path 1105.

FIG. 12 also shows an example of a method 1200 that includes an access block 1202 for accessing data, an analysis block 1204 for analyzing data with respect to an objective function and constraints, an information block 1206 for determining information based at least in part on the analyzing and a render block 1208 for rendering information to a display (e.g., optionally graphic controls that may be selected for display of information, etc.).

In the example of FIG. 12, the method 1200 may include implementing one or more modules. For example, the method 1200 may be performed by a system that includes modules such as a composition module 1212 (e.g., for composition of fluid in a pipeline, a piece of equipment, etc.), a flow rate module 1214 (e.g., for one or more fluid flow rates), a size module 1216 (e.g., for size of one or more pieces of equipment), an elevation module 1218 (e.g., for elevation for one or more points), a path to water module 1220 (e.g., for assessing leakage risks), a seismology module 1222 (e.g., for assessing seismic risk to a network, etc.), a lithology module 1224 (e.g., for structural engineering of a network), a mass module 1226 (e.g., for mass of a pipeline, equipment, optionally with fluid therein), an environmental module 1228 (e.g., for weather, etc.), and one or more other modules 1230.

Referring again to the scenario 101, as shown in the GUI 1201 of FIG. 12, four points are indicated as being associated with information that may be available for rendering to a display. For example, point 1 may be for a risk of viscosity being too high in the months of December and January for the path 1105 as the southerly path may include portions shaded due to topography (e.g., being on a north face). As another example, point 2 may provide for installation of a solar powered flow meter (e.g. based on sun exposure, etc.) at or along a portion of the path 1103.

As indicated in the example of FIG. 12, the GUI 1201 may be operatively coupled to a system that can implement the method 1200. For example, the render block 1208 of the method 1200 may be implemented by a system that calls for rendering information such as one or more of the points to the GUI 1201. As an example, a method may include receiving an input signal and, in response to the input signal, rendering information to a GUI such as the GUI 1201. In such an example, consider a user navigating a cursor to a displayed point on a display (e.g., a graphic control), a user touching a displayed point on a display (e.g., a graphic control), etc. where a system registers the user input and executes instructions in response to the registered user input, for example, by rendering information to the display (e.g., in a call out window, another window, etc.).

As an example, a system may include one or more application programming interfaces (APIs). As an example, a display device may be configured to issue API calls responsive to receipt of user input. For example, where a display device is a touch sensitive display, a user may touch a point on a GUI where the point is associated with a graphic control that can issue an API call to a system. In such an example, the system may respond to the API call by calling for rendering of information to the GUI. As an example, the system may include three-dimensional coordinates that represent a scenario such that an API call that includes coordinates is sufficient to instruct the system (e.g., as API parameter values) as to a type of action to be performed for that API call.

Referring again to the GUI 1201 of FIG. 12, where a user selects the point 1, screen coordinates for that point may be included in an API call to a system where the system associates the screen coordinates with a terrain and, for example, with a path (e.g., the path 1105 of the scenario 1101). The system may then access information, perform calculations, etc. associated, with that point (e.g., underlying terrain, path, etc.) and call for rendering (e.g., by a graphics subsystem) information to the GUI (e.g., at or near the point, in a side window, etc.).

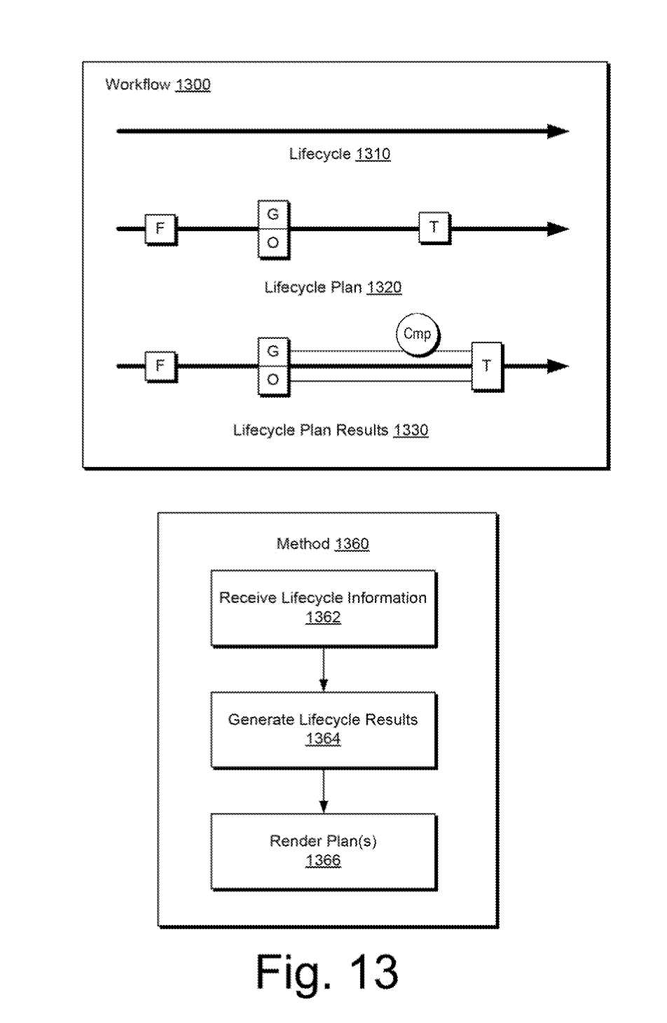

FIG. 13 shows an example of a workflow 1300 and an example of a method 1360. As shown, the workflow 1300 may account for one or more lifecycle factors, which may, for example, be presented along a lifecycle timeline 1310. For example, a task or tasks of the workflow 1300 may include selecting events, processes, etc. for a project and associating those selections with the lifecycle timeline 1310 to generate a lifecycle plan timeline 1320. As an example, method may include processing information associated with a lifecycle plan timeline and generating lifecycle plan results. For example, such a method may process the lifecycle plan timeline 1320 and generate results where at least a portion of the results may be presented as a lifecycle plan results timeline 1330.

As shown in the example of FIG. 13, the lifecycle plan may include hydraulic fracturing (F), gas and oil production (G, O) and remediation at an end of the lifecycle to return at least one path to a trail (T), for example, akin to a rails-to-trails program. The lifecycle plan timeline 1320 illustrates these various lifecycle factors with respect to time, for example, in an approximate manner. Using such factors as input, a system may analyze them, optionally with respect to an optimization process that may include optimizing an object function with respect to a solution space that may be defined at least in part by one or more constraints. In such an example, analysis results may include one or more lifecycle timings and optionally one or more paths, which may include pipelines, equipment, etc. As shown with respect to the lifecycle plan results timeline 1330, a path may be output for gas transport and a path may be output for oil transport where, for example, at a particular time, the lifecycle plan results indicate that a compressor may be added to the gas transport path. In such an example, addition of the compressor at a point in time may be based on a decline in pressure (e.g., from a producing well). In such an example, overall gas production may be increased where the compressor aids in gas transport to compensate for the decline in pressure. At a latter point in time, an economic balance may indicate that the cost of production may exceed value of gas produced. At such a time, plan results may indicate that a conversion of one or more of the production paths may be converted to a trail or otherwise remediated.

In the example of FIG. 13, the method 1360 includes a reception block 1362 for receiving lifecycle information, a generation block 1364 for generating lifecycle results and a render block 1366 for rendering at least one plan based at least in part on the lifecycle results.

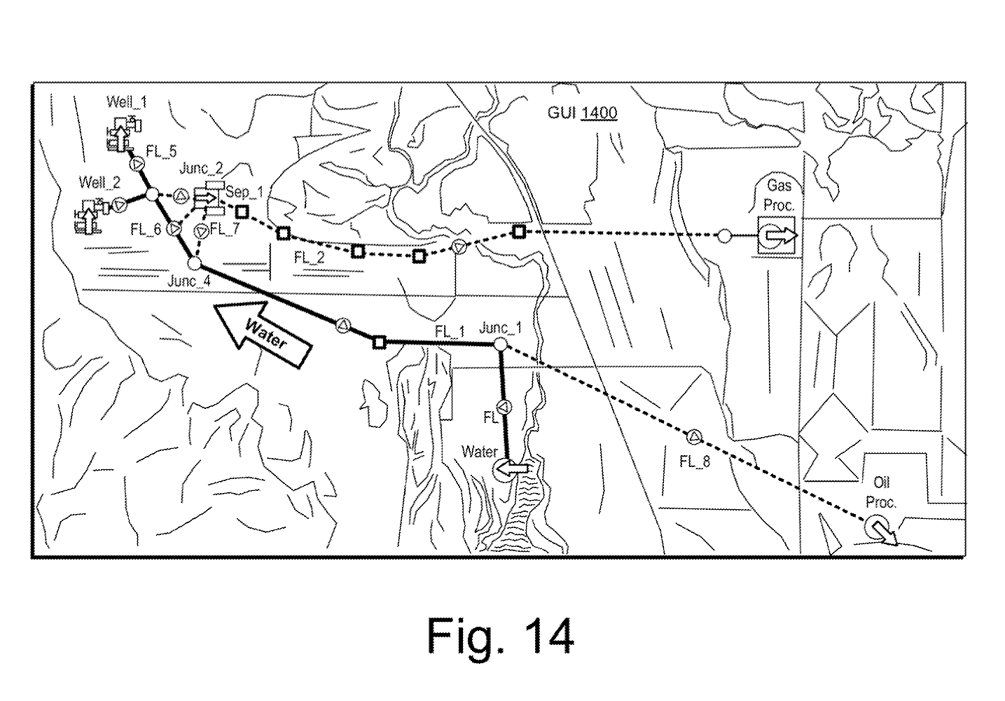

FIGS. 14, 15 and 16 show examples of graphical user interfaces (GUIs) 1400, 1500 and 1600 that correspond to lifecycle plans. The GUIs 1400, 1500 and 1600 illustrate examples of hydraulic fracturing followed by gas and oil production followed by utilization of a compressor along a gas production path. Such examples may correspond to the lifecycle plan results timeline 1330 of the workflow 1300 of FIG. 13.

As an example, a production engineer may perform a workflow whereby a design scenario is proposed followed by a simulation to generate simulation results. As an example, such a simulation may at least in part be performed using the PIPESIM® framework. As an example, based at least in part on simulation results, the production engineer may modify the design, for example, to achieve certain criteria such as, for example, delivery flow rates and pressure, avoidance of flow assurance issues (e.g., maximum erosional velocities, hydrate formation, wax deposition, etc.).

As an example, a system may include one or more modules that provide for development of at least a portion of a production network based at least in part on described goals and constraints. In such an example, the system may develop a design that optimizes one or more objectives (e.g., minimum costs, maximum value, minimum risk, etc.).

As an example, a workflow may include setting at least one goal, such as, for example: “connect wells to processing facility”. Such a workflow may include setting at least one constraint, such as, for example: “avoid regions X, Y, Z; ensure flow; avoid wax and erosion”. As an example, such a workflow may include setting at least one objective, such as, for example: “minimize costs”.

As an example, a workflow may include setting one or more lifecycle factors. In such an example, the workflow may consider dynamics of a project that may occur over time. For example, a lifecycle may consider one or more fracturing processes that may act to increase production of a resource. In such an example, fracturing may be performed at one or more stages (e.g., multistage hydraulic fracturing). As an example, hydraulic fracturing may benefit from a reliable source of water for at least one stage of hydraulic fracturing. As an example, a network may be developed that allows for multidirectional flows. As an example, a network may be developed that allows for flow of a first resource over a period of time and flow of a different resource over a period of time. For example, a pipeline with appropriate equipment may provide for flow of water from a water source to a well site for fracturing for a first period of time and then at least a portion of that pipeline with appropriate equipment may provide for flow of a resource from the well site to a facility for a second subsequent period of time. In such an example, where fracturing is to be performed in stages with production between stages, the flows may be switched as part of a lifecycle plan.

As an example, consider the GUI 1400 of FIG. 14 where initially a water source and pipeline are desired to provide water for fracturing and preparing wells for production. As part of an example workflow, given such input, a design system may provide an optimized pipeline trajectory to maintain right-of-way, minimize production costs, potentially selecting from a number of available sources capable of providing desired water rates. The GUI 1400 of FIG. 14 shows dashed lines and solid lines where solid lines represent a flow path for water from a water source to well sites. As part of a lifecycle, such a flow path may be implemented for a period of time (e.g., or periods of time) to accomplish a lifecycle goal (e.g., or lifecycle goals).

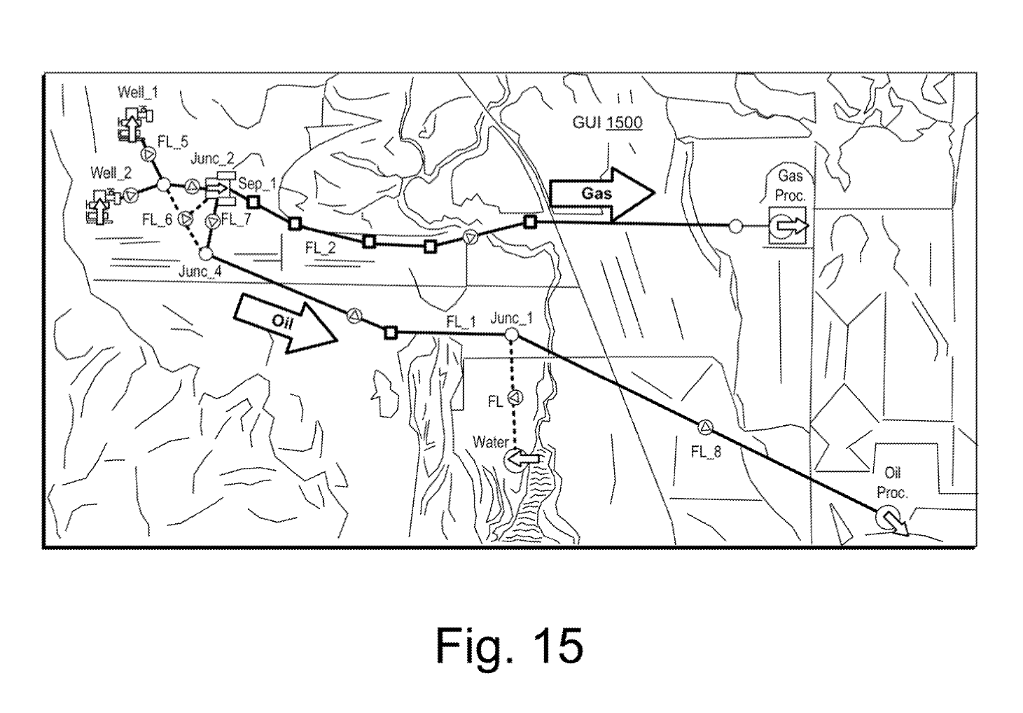

In the GUI 1500 of FIG. 15, solid lines indicate oil and gas production paths while dashed lines indicate paths that may exist but that are not in use for at least a period of time. For example, equipment may be part of a plan for production and/or separation of oil and gas and optionally water. In such an example, liquids may be diverted to processing facilities along the pipeline that was used for supplying water for fracturing. As shown, separated gas may be delivered along a pipeline that may be optimized with a goal of minimizing use of compression and, for example, constrained to less than erosional velocities.

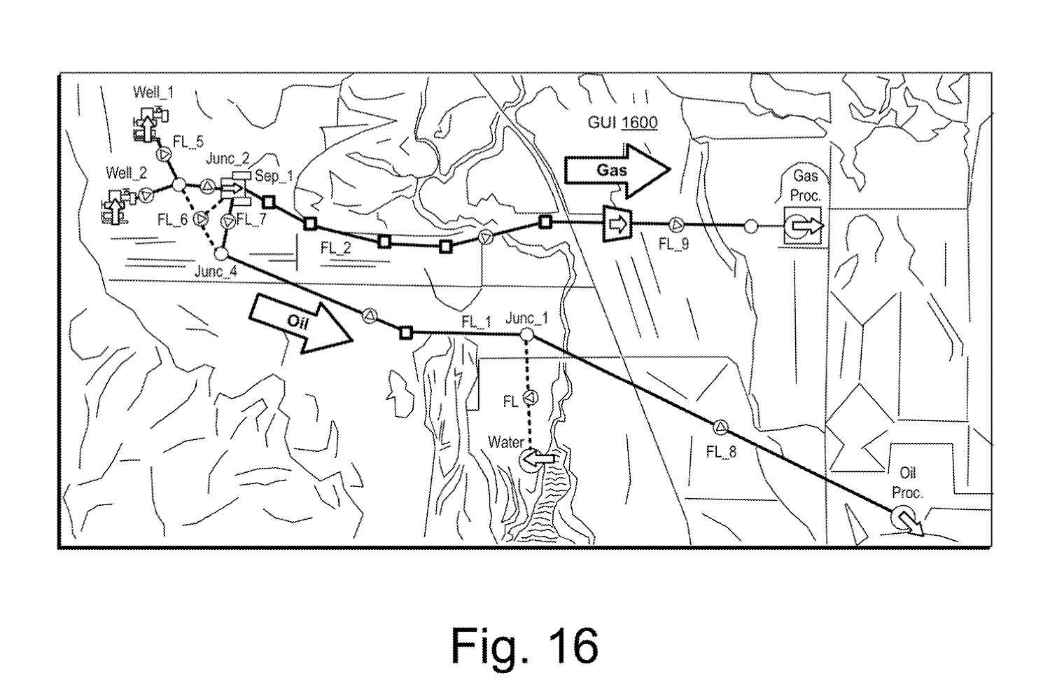

In the GUI 1600 of FIG. 16, the plan is shown at a later time of a lifecycle where, for example, after performing procedures illustrated with respect to the GUIs 1400 and 1500 of FIGS. 14 and 15 a number of times, one or more of the wells may no longer produce economically, for example, without additional investment, intervention, etc. (e.g., additional equipment, power, etc.). As shown in the GUI 1600, a compressor and other equipment may be installed along the gas production path. In such an example, the equipment may compensate for well depletion (e.g., pressure decline, etc.). In such an example, addition of the compressor may provide for compression of gas from the well to continue transport of such gas to the gas processing facility.

As explained, a system may include one or more modules that can implement design assistant functionality, for example, to provide production system automation based on goals and constraints. Such a system may optionally consider one or more lifecycle factors. As an example, such factors may be specified, optionally at approximate times where an analysis thereof provides more specific times. In such an example, equipment, resources, etc. may be planned to effectuate at least part of a lifecycle based at least in part on such specific times. As an example, a system may include for updating a development plan based at least in part on one or more actions taken at a point in time. For example, where a certain action is taken, information associated with that action may be input to the system to generate updated lifecycle plan results. As an example, where a certain previously planned action is not taken, input may be received by a system such that the system can generate updated lifecycle plan results that account for such non-action. As an example, a system may include one or more features of a simulator such as a simulator of the PIPESIM® framework. As an example, a lifecycle module or modules may be included as part of a simulator (e.g., as part of a simulator framework).

As an example, a method can include rendering terrain and equipment locations to a display; assigning one or more domain constraints; analyzing an objective function associated with the terrain and the equipment locations subject to at least one of the one or more domain constraints; and rendering information to the display based at least in part on the analyzing. In such an example, rendering information may include rendering at least one path that connects at least two of the equipment locations. As an example, rendering information may include rendering a graphic to a display that indicates a violation of at least one of the one or more domain constraints.

As an example, a method may include assigning one or more report constraints and rendering information at least in part as a graphic to a display that indicates a violation of at least one of the one or more report constraints (e.g., based in part on an analysis, etc.). As an example, a method may include assigning one or more report constraints and rendering information at least in part as a graphic to a display that indicates a violation of at least one of one or more domain constraints and a violation of at least one of the one or more report constraints.

As an example, a method may include analyzing an objective function that accounts for topography of at least a portion of a terrain (e.g., optionally based on one or more domain constraints). As an example, a method may include analyzing an objective function that accounts for topology of at least a portion of a network that includes at least one equipment location (e.g., optionally based on one or more domain constraints, etc.). As an example, a method may include analyzing an objective function that accounts for topography of at least a portion of a terrain and topology of at least a portion of a network that includes at least one equipment location. As an example, an analysis of an objective function may include minimizing a value of the objective function, for example, consider a cost function where an analysis of the cost function is subject to one or more constraints and where the analysis aims to minimize cost.

As an example, a method may include rendering information at least in part as a graphic control to a display where the graphic control is configured to issue an application programming interface (API) call to a computing system that is configured to perform an analysis of one or more objective functions subject to one or more constraints.

As an example, a system can include a processor; memory operatively coupled to the processor; and one or more modules storable in the memory that include instructions executable by the processor to instruct the system to render terrain and equipment locations to a display; assign one or more domain constraints; analyze an objective function associated with the terrain and the equipment locations subject to at least one of the one or more domain constraints; and render information to the display based at least in part on an analysis of the objective function. In such an example, the system may include a module or modules to instruct the system to assign at least one domain constraint based on at least one environmental condition associated with the terrain, to instruct the system to assign at least one domain constraint based on property rights associated with the terrain, to instruct the system to assign at least one domain constraint based on elevations associated with the terrain, to instruct the system to assign at least one domain constraint based on hydrodynamics associated with the terrain, to instruct the system to assign at least one domain constraint based on fluid properties associated with the terrain, to instruct the system to assign at least one domain constraint based on avalanche risk associated with the terrain, and/or to instruct the system to assign at least one domain constraint based on terrain material slide risk associated with the terrain. As an example, a domain constraint may be based on geomechanics associated with a terrain (e.g., as to structural mechanics to support a pipeline, equipment, etc.).

As an example, one or more computer-readable storage media can include computer-executable instructions executable by a computer to instruct the computer to: render terrain and equipment locations to a display; assign one or more domain constraints; analyze an objective function associated with the terrain and the equipment locations subject to at least one of the one or more domain constraints; and render information to the display based at least in part on an analysis of the objective function. In such an example, the one or more computer-readable storage media may include computer-executable instructions executable by a computer to instruct the computer to assign one or more of the domain constraints based on topography of at least a portion of the terrain and/or computer-executable instructions executable by a computer to instruct the computer to assign one or more of the domain constraints based on topology of at least a portion of a network that includes at least one of the equipment locations.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

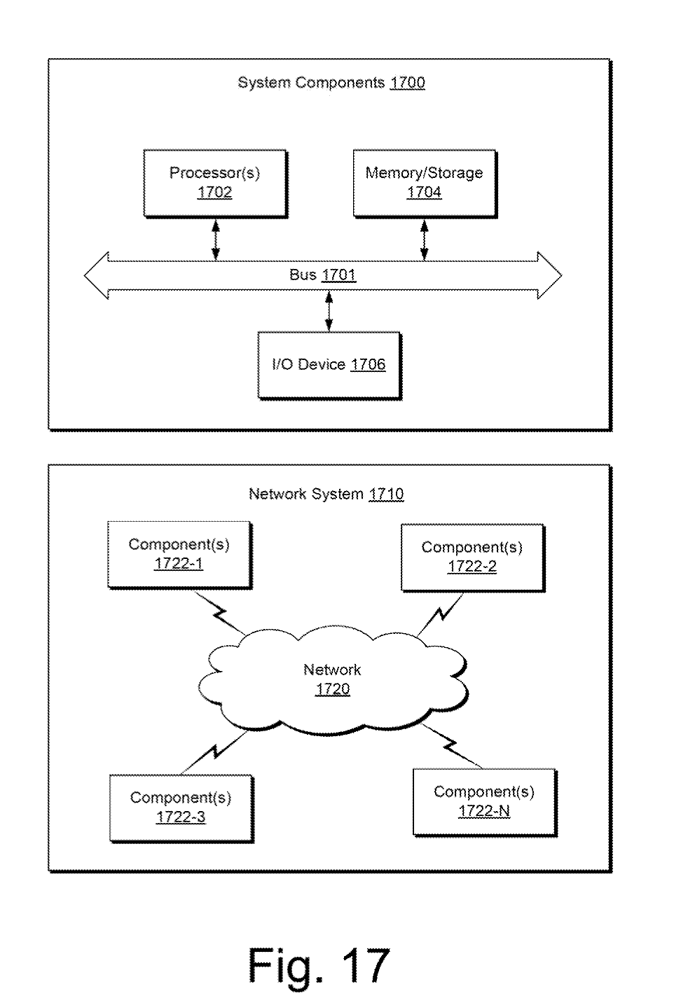

FIG. 17 shows components of an example of a computing system 1700 and an example of a networked system 1710. The system 1700 includes one or more processors 1702, memory and/or storage components 1704, one or more input and/or output devices 1706 and a bus 1708. In an example embodiment, instructions may be stored in one or more computer-readable media (e.g., memory/storage components 1704). Such instructions may be read by one or more processors (e.g., the processor(s) 1702) via a communication bus (e.g., the bus 1708), which may be wired or wireless. The one or more processors may execute such instructions to implement (wholly or in part) one or more attributes (e.g., as part of a method). A user may view output from and interact with a process via an I/O device (e.g., the device 1706). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1710. The network system 1710 includes components 1722-1, 1722-2, 1722-3, . . . 1722-N. For example, the components 1722-1 may include the processor(s) 1702 while the component(s) 1722-3 may include memory accessible by the processor(s) 1702. Further, the component(s) 1722 may include an I/O device for display and optionally interaction with a method. The network may be or include the Internet, an intranet, a cellular network, a satellite network, etc.

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method comprising:
rendering terrain and equipment locations to a display;
assigning one or more domain constraints;
analyzing an objective function associated with the terrain and the equipment locations subject to at least one of the one or more domain constraints; and
rendering information to the display based at least in part on the analyzing.

2. The method of claim 1 wherein the rendering information comprises rendering at least one path that connects at least two of the equipment locations.

3. The method of claim 1 wherein the rendering information comprises rendering a graphic to the display that indicates a violation of at least one of the one or more domain constraints.

4. The method of claim 1 comprising assigning one or more report constraints wherein the rendering information comprises rendering a graphic to the display that indicates a violation of at least one of the one or more report constraints.

5. The method of claim 1 comprising assigning one or more report constraints wherein the rendering information comprises rendering a graphic to the display that indicates a violation of at least one of the one or more domain constraints and a violation of at least one of the one or more report constraints.

6. The method of claim 1 wherein the objective function accounts for opo aphy of at least a portion of the terrain.

7. The method of claim 1 wherein the objective function accounts for topology of at least a portion of a network that includes at least one of the equipment locations.

8. The method of claim 1 wherein the objective function accounts for topography of at least a portion of the terrain and topology of at least a portion of a network that includes at least one of the equipment locations.

9. The method of claim 1 wherein the rendering information comprises rendering a graphic control to the display wherein the graphic control is configured to issue an application programming interface call to a computing system that performs at least the analyzing.

10. A system comprising:
a processor;
memory operatively coupled to the processor; and
one or more modules storable in the memory that comprise instructions executable by the processor to instruct the system to
render terrain and equipment locations to a display;
assign one or more domain constraints;
analyze an objective function associated with the terrain and the equipment locations subject to at least one of the one or more domain constraints; and
render information to the display based at least in part on an analysis of the objective function.

11. The system of claim 10 comprising a module storable in the memory that comprise instructions executable by the processor to instruct the system to assign at least one domain constraint based on at least one environmental condition associated with the terrain.

12. The system of claim 10 comprising a module storable in the memory that comprises instructions executable by the processor to instruct the system to assign at least one domain constraint based on property rights associated with the terrain.

13. The system of claim 10 comprising a module storable in the memory that comprises instructions executable by the processor to instruct the system to assign at least one domain constraint based on elevations associated with the terrain.

14. The system of claim 10 comprising a module storable in the memory that comprises instructions executable by the processor to instruct the system to assign at least one domain constraint based on hydrodynamics associated with the terrain.

15. The system of claim 10 comprising a module storable in the memory that comprises instructions executable by the processor to instruct the system to assign at least one domain constraint based on fluid properties associated with the terrain.

16. The system of claim 10 comprising a module storable in the memory for execution by the processor to instruct the system to assign at least one domain constraint based on avalanche risk associated with the terrain.

17. The system of claim 10 comprising a module storable in the memory that comprise instructions executable by the processor to instruct the system to assign at least one domain constraint based on terrain material slide risk associated with the terrain.

18. One or more computer-readable storage media comprising computer-executable instructions executable by a computer to instruct the computer to
render terrain and equipment locations to a display;
assign one or more domain constraints;
analyze an objective function associated with the terrain and the equipment locations subject to at least one of the one or more domain constraints; and
render information to the display based at least in part on an analysis of the objective function.

19. The one or more computer-readable storage media of claim 18 comprising computer-executable instructions executable by a computer to instruct the computer to assign one or more of the domain constraints based on topography of at least a portion of the terrain.

20. The one or more computer-readable storage media of aim 18 comprising computer-executable instructions executable by a computer to instruct the computer to assign one or more of the domain constraints based on topology of at least a portion of a network that includes at least one of the equipment locations.
